(19) United States
(12) Patent Application Publication
(10) Pub. No.: US 2003/0065117 A1
(43) Pub. Date: Apr. 3, 2003

(54) Modified silicone compound, process of producing the same, and cured object obtained therefrom

(76) Inventors: Narsi Reddy Poreddy, Ibaraki (JP); Teruyuki Hayashi, Ibaraki (JP); Masato Tanaka, Ibaraki (JP); Jun-ichi Ishikawa, Chiba (JP); Kenji Iwata, Chiba (JP); Takaharu Abe, Chiba (JP); Masayoshi Itoh, Chiba (JP)

Correspondence Address: BURNS DOANE SWECKER & MATHIS L L P, POST OFFICE BOX 1404, ALEXANDRIA, VA, 22313-1404, US

(21) Appl. No.: 10/221,109

(22) PCT Filed: Mar. 8, 2001
(86) PCT No.: PCT/JP01/01823

(30) Foreign Application Priority Data
Mar. 9, 2000 (JP) 2000-64951
Mar. 9, 2000 (JP) 2000-64952
Mar. 9, 2000 (JP) 2000-64953
Mar. 9, 2000 (JP) 2000-64954
Mar. 14, 2000 (JP) 2000-70392

(51) Int. Cl. C07F 7/18; C08F 130/08

(52) U.S. Cl. 526/279; 556/455

(57) ABSTRACT

It is here intended to provide a modified silicone compound having excellent heat-resistant properties and a process of producing the same, and there is disclosed a modified silicone compound having an Si—H bond and an unsaturated bond, represented by the general formula (1):

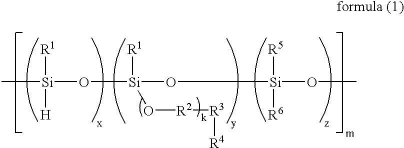

(wherein R¹ and R⁴ are each hydrogen or a monovalent organic group; R² is a divalent organic group; R⁴ and R⁶ are each a monovalent organic group and may be the same or different; R³ is a divalent group having an unsaturated carbon-carbon bond, represented by —C≡C— or —C(R⁷)═C(R⁸)—; and R⁷ and R⁸ are the same as defined in R¹).

### TECHNICAL FIELD

The present invention relates to a modified silicone compound useful for heat resistant and combustion resistant materials characterized by having an Si—H bond and an unsaturated bond in the molecule, and a process of producing the same. The modified silicone compound is applicable to highly heat resistant adhesive agents, releasing agents and sealants.

The present invention relates to a modified silicone compound useful for heat resistant and combustion resistant materials, characterized by having an Si—H bond and a carbon-carbon triple bond and/or a double bond in the molecule, and a process of producing the same. The modified silicone compound is useful as the starting compound for heat resistant materials, light-emitting and photoelectric conversion materials, silicon-based ceramic materials, and heat resistant adhesive agents, releasing agents and sealants. An organosilicon compound having an unsaturated carbon-carbon bond is an important polymer for its reactivity which can allow itself to be crosslinked by addition/cyclization reactions to realize thermosetting characteristics and high thermal stability. Moreover, an organosilicon compound having the carbon-carbon triple and/or double bond and Si—H bond is an important polymer, because it can be crosslinked by hydrosilylation for which its reactivity is utilized to realize thermosetting characteristics and high thermal stability.

### BACKGROUND ART

A number of engineering plastics have been researched and developed as heat resistant materials which are light, excellent in mechanical properties and moldable.

Organosilicon compounds having the carbon-carbon triple bond have been attracting attention as heat resistant materials or constituents therefor. For example, it is reported that a poly(ethynylenesilylene) has high thermal stability, losing weight only by 20% at 1000° C. (J. Polym. Sci., A, Polym. Chem., 28, 955 (1990)), and a poly(diethynylenesilylene) is a polymer having very high thermal stability, decomposed only to ten-odd %, even when heated to 1400° C. (J. Organomet. Chem., 449, 111 (1993)).

The inventors of the present invention have found that a thermosetting silicon-based compound having a recurring unit containing the carbon-carbon triple bond and Si—H bond in the molecule is very highly resistant to heat (Japanese Patent Laid-open Publication No. 7-102069). In particular, it is improved in thermal stability, and it is reported that a poly(ethynylene(1,3-phenylene)ethynylene(phenylsilylene) is thermally decomposed to only several percent at 1000° C. (Macromolecules, 30, 694 (1997)).

The cured product produced by thermally treating the above organosilicon compound at 50 to 700° C. is very excellent in resistance to heat and oxidation, and expected to go into various areas as a highly heat resistant thermosetting resin, although there is still room for improvement in bending strength, resistance to impact or the like. The thermosetting resin having the above functions should find still wider applicable areas, if it could be produced from a more common starting material.

On the other hand, silicone compounds have been used in various industrial areas as releasing agents and sealants. However, taking resistance to heat, these compounds, although very widely used organosilicon compounds, are less resistant to heat than the above-described silicon compounds. Some of the methods to improve resistance of silicone compounds to heat incorporate a heat resistant stabilizer, e.g., iron oxide, cerium compound, oxide or hydroxide of a lanthanum-based rare-earth metal, allyl urethane, or polyethynylpyridine. However, practical service temperature of each of these stabilizers is limited to 300° C.

A block copolymer, produced by ring-opening polymerization of cyclic methylvinyl siloxane oligomer and cyclic methyl hydrogen siloxane oligomer through the equilibrium reaction process, is known as the silicone compound having the Si—H and an unsaturated carbon-carbon bonds, and the ceramic material of the above compound set by firing at 300 to 1300° C. is also known (Japanese Patent laid-open Publication No. 10-81750). However, the block copolymer produced by the method disclosed by the publication as a starting compound for ceramic materials invariably contains a low-molecular-weight oligomer, because it is produced by the polymerization involving the equilibrium reactions. Moreover, the publication is silent on bending strength, resistance to heat, resistance to oxidation or the like of the cured product, although mentioning resistance to heat because the compound is used after it is fired at high temperature into a ceramic material.

The inventors of the present invention have found that a silicone compound containing the Si—H bond can be greatly improved in resistance to heat and combustion, when modified with an alcohol compound containing an unsaturated bond to have the carbon-carbon triple bond in the molecule in addition to the Si—H bond, reaching the present invention.

They have also found that a silicone compound containing the Si—H bond can be greatly improved in resistance to heat and combustion, when modified with a compound containing an unsaturated bond to have the unsaturated bond in the molecule in addition to the Si—H bond, reaching the present invention.

It is an object of the present invention to provide an industrially advantageous silicon-based polymer having the carbon-carbon triple or double bond, which is thermally crosslinkable, or carbon-carbon triple or double bond and Si—H bond economically and industrially advantageously.

### DISCLOSURE OF THE INVENTION

(a) A modified silicone compound having an Si—H bond and an unsaturated carbon-carbon bond, represented by the general formula (1):

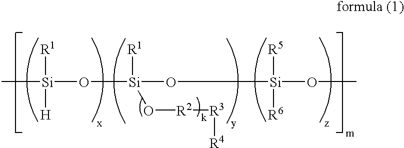

(wherein R¹ and R⁴ are each hydrogen or a monovalent organic group; R² is a divalent organic group; R⁵ and R⁶ are each a monovalent organic group and may be the same or different; R³ is a divalent group having an unsaturated carbon-carbon bond, represented by —C≡C— or —C(R⁷)═C(R⁸)—; R⁷ and R⁸ are each hydrogen or a monovalent organic group and may be the same or different; k is 0 or 1; y is more than 0 but less than 1; x and z are each 0 or more but less than 1, satisfying the relationship x+y+z=1; x is not 0 when R¹ is not hydrogen; m is an integer of 3 or more; but constituent elements may be optionally arranged; each of the structures ( )ₓ, ( )_{y} and ( )_{z} may contain 2 or more different structures so long as they are defined; and R¹ may be a monovalent organic group represented by (O—R²)ₖ—R³—R⁴).

(b) A cured product obtained by setting the modified silicone compound according to (a) thermally and/or in the presence of a catalyst.

(c) The modified silicone compound having the Si—H and the carbon-carbon triple bond according to (a), wherein R¹, R³ and k in the general formula (1) are a monovalent organic group, —C≡C— and 1, respectively.

(d) A cured product obtained by setting the modified silicone compound according to (c) thermally and/or in the presence of a catalyst.

(e) The modified silicone compound having the Si—H bond and the carbon-carbon triple bond according to (a), which is represented by the general formula (2):

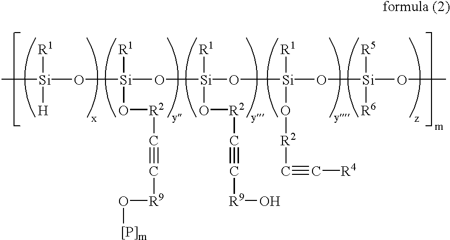

(wherein R¹ is a monovalent organic group; R², R⁴, R⁵ and R⁶ are the same as R², R⁴, R⁵ and R⁶ defined in (a); R⁹ is a divalent organic bond; x is more than 0 but less than 1; y″, y″′, y″″ and z are each 0 or more but less than 1, satisfying the relationship x+y″+y″′+y″″+z=1; y″ and y″′ are not 0 simultaneously; m is an integer of 3 or more; P is a composition of the polymer in the []ₘ; but constituent elements may be optionally arranged).

(f) A cured product obtained by setting the modified silicone compound according to (e) thermally and/or in the presence of a catalyst.

(g) The modified silicone compound having the Si—H bond and the carbon-carbon triple bond according to (a), which is represented by the general formula (3):

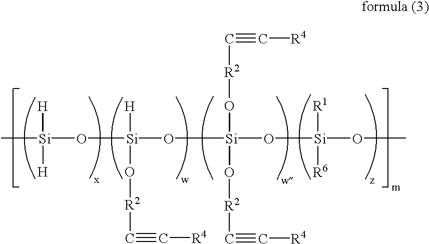

(wherein R¹, R², R⁴ and R⁶ are the same as R¹, R₂, R₄ and R⁶ defined in (a); x and w″ are each 0 or more but less than 1, z is 0 or more but less than 1; w is 0 or more but 1 or less, satisfying the relationship x+w+w″+z=1; w and w″ are not 0 simultaneously; x and w may be 0 simultaneously when R¹ is hydrogen; x and w are not 0 simultaneously when R¹ is not hydrogen; m is an integer of 3 or more; but constituent elements may be optionally arranged).

(h) A cured product obtained by setting the modified silicone compound according to (g) thermally and/or in the presence of a catalyst.

(i) The modified silicone compound having the Si—H bond and the carbon-carbon double bond according to (a), wherein —R³ and k in the general formula (1) are —C(R⁷)═C(R⁸)— and 1, respectively.

(j) A cured product obtained by setting the modified silicone compound according to (i) thermally and/or in the presence of a catalyst.

(k) The modified silicone compound having the Si—H bond and the carbon-carbon double bond according to (a), which is represented by the general formula (4):

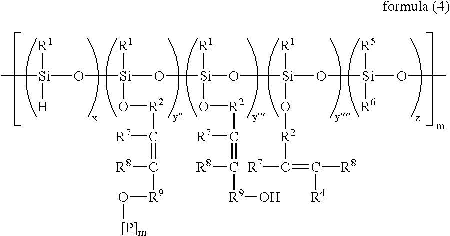

(wherein R¹ is a monovalent organic group; R², R⁴, R⁵, R⁶, R⁷ and R⁸ are the same as R², R⁴, R⁵, R⁶, R⁷ and R⁸ defined in (a); R⁹ is the same as R⁹ defined in (e); x and y″″ are each more than 0 but less than 1; y″, y″′ and z are each 0 or more but less than 1; satisfying the relationship x+y″+y″′+z=1; y″ and y″′ are not 0 simultaneously; m is an integer of 3 or more; P is a composition of the polymer in the []ₘ; but constituent elements may be optionally arranged).

(l) A cured product obtained by setting the modified silicone compound according to (k) thermally and/or in the presence of a catalyst.

(m) The modified silicone compound having the Si—H bond and the carbon-carbon triple bond according to (a), which is represented by the general formula (5):

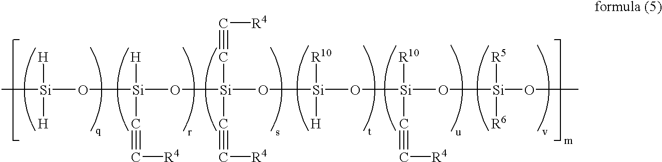

(wherein R⁴, R⁵ and R⁶ are the same as R⁴, R⁵ and R⁶ defined in (a); R¹⁰ is a monovalent organic group; q, r, s, t, u and v are each 0 ore more but less than 1, satisfying the relationship q+r+s+t+u+v=1; r, s and u are not 0; q, r and t are not 0 simultaneously; m is an integer of 3 or more; but constituent elements may be optionally arranged).

(n) A cured product obtained by setting the modified silicone compound according to (m) thermally and/or in the presence of a catalyst.

(o) The modified silicone compound having the Si—H bond and the carbon-carbon double bond according to (a), which is represented by the general formula (6):

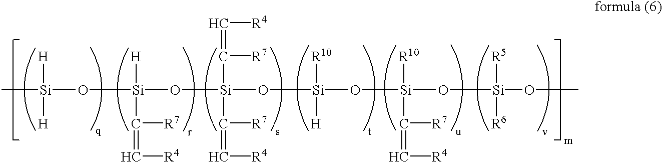

(wherein R⁴ is a monovalent organic group; R₅, R⁷ and R⁷ are the same as R⁵, R⁷ and R⁷ defined in (a); R¹⁰ is the same as R¹⁰ defined in (m); q, r, s, t, u and v are the same as q, r, s, t, u and v defined in (m); m is an integer of 3 or more; but constituent elements may be optionally arranged).

(p) A cured product obtained by setting the modified silicone compound according to (o) thermally and/or in the presence of a catalyst.

(q) The process of producing the modified silicone compound according to (c) or (e), comprising a step of reacting an H-silicone represented by the general formula (7):

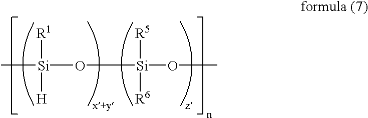

(wherein R¹, R⁵ and R⁶ are the same as R¹, R⁵ and R⁶ defined in (a); x′+y′ is more than 0 but 1 or less, and z′ is 0 or more but less than 1, satisfying the relationship x′+y′+z′=1, and n is an integer of 3 or more), in a dehydrogenation manner, with an alkynyl alcohol represented by HO—R²—C≡C—R⁴ (wherein R² and R⁴ are the same as R² and R⁴ defined in (a)) and/or an alkynylenediol represented by HO—R²—C≡C—R⁹—OH (wherein R² is the same as R² defined in (a) and R⁹ is the same as R⁹ defined in (e)).

(r) The process of producing the modified silicone compound according to (g), comprising a step of reacting an H-silicone represented by the general formula (8):

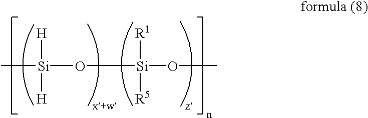

(wherein R¹ and R⁵ are the same as R¹ and R⁵ defined in (a); x′, w′ and z′ are each 0 or more but less than 1, satisfying the relationship x′+w′+z′=1; x, and w′ are not 0 simultaneously; n is an integer of 3 or more; but constituent elements may be optionally arranged) with an alkynyl alcohol represented by HO—R²—C≡C—R⁴ (wherein R² and R⁴ are the same as R² and R⁴ defined in (a)) in the presence of a dehydrocoupling catalyst.

(s) The process of producing the modified silicone compound according to (i) or (k), wherein an H-silicone represented by the general formula (7) is reacted in a dehydrogenation manner with an alkenyl alcohol represented by HO—R²—C(R⁷)═C(R⁸)—R⁴ (wherein R², R⁴, R¹ and R¹ are the same as R², R⁴, R⁷ and R⁸ defined in (a)) and/or an alkenylenediol represented by HO—R²—C(R⁷)═C(R⁸)—R⁹—OH (wherein R², R⁷ and R⁸ are the same as R², R₇ and R⁸ defined in (a) and R⁹ is the same as R⁹ defined in (e)).

(t) The process of producing the modified silicone compound according to (m), wherein an H-silicone represented by the general formula (9):

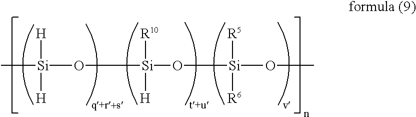

(wherein R⁵ and R⁶ are the same as R⁵ and R⁶ defined in (a); R¹⁰ is the same as R¹⁰ defined in (m); q′, r′, s′, t′, u′ and v′ are each 0 or more but less than 1, satisfying the relationship q+r′+s′+t′+u′+v′=1; n is an integer of 3 or more; but constituent elements may be optionally arranged) is reacted with a compound having an ethynyl group represented by H—C═C—R⁴ (wherein R⁴ is the same as R⁴ defined in (a)) in the presence of a dehydrocoupling catalyst.

(u) The process of producing the modified silicone compound according to (o), wherein a silicone polymer containing the Si—H bond and represented by the general formula (9) is reacted with a compound having an ethynyl group and represented by R⁴—C≡C—R⁷ (wherein R⁴ and R⁷ are the same as R⁴ and R⁷ defined in (a)) in the presence of a hydrosilylation catalyst.

### BEST MODE FOR CARRYING OUT THE INVENTION

The present invention will be described in more detail.

The present invention is directed to a modified silicone compound having an Si—H bond and an unsaturated carbon-carbon bond represented by the general formula (1).

(i) General formula (1)

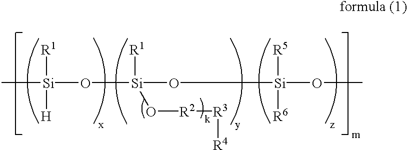

(wherein R¹ and R⁴ are each hydrogen or a monovalent organic group; R² is a divalent organic group; R⁵ and R⁶ are each a monovalent organic group, which may be the same or different; R³ is a divalent group having an unsaturated carbon-carbon bond, represented by —C≡C— or —C(R⁷)═C(R⁸)—; R⁷ and R⁸ are each hydrogen or a monovalent organic group, which may be the same or different; k is 0 or 1; y is more than 0 but less than 1, and x and z are each 0 or more but less than 1, satisfying the relationship x+y+z=1, x being not 0 when R¹ is not hydrogen; m is an integer of 3 or more; but constituent elements may be optionally arranged; each of the structures ( )ₓ ( )_{y} and ( )_{z} may contain 2 or more different structures when they are defined; and R¹ may be a monovalent organic group represented by (O—R²)ₖ—R³—R⁴).

“Each of the structures ( )ₓ, ( )_{y} and ( )_{z} may contain 2 or more different structures when they are defined” means that, taking the general formula (2) as an example, ( )_{y} contains 3 types of structures, which is included in the general formula (1).

In the present invention, “the constituent elements may be optionally arranged” means that, for example, x, y and z only indicate a compositional ratio, and do not necessarily indicate a block structure, by which is meant that a block copolymer and a random copolymer can be included.

In this specification, each of m and n indicates degree of polymerization, which is average degree of polymerization.

x is 0.01 to 0.99, preferably 0.09 to 0.90, more preferably 0.3 to 0.90; y is 0.01 to 0.99, preferably 0.09 to 0.90, more preferably 0.30 to 0.70; and z is 0 or more but 0.99 or less, preferably 0 or more but 0.70 or less, more preferably 0 or more but 0.52 or less.

Description of the Mono- or Di-Valent Organic Group

In each of the general formulae, the symbols R¹ to R¹⁰ are defined to be common to all the formula.

In this description, the monovalent organic group is not limited, so long as it is monovalent and organic. The monovalent organic groups useful for the present invention include alkyl groups of 1 to 30 carbon atoms, which may contain a halogen atom, or hydroxyl or ether group, e.g., methyl, ethyl, hexyl, octyl, octadecyl, 3,3,3-trifluoropropyl, fluoromethyl and 2-methoxyethyl; alkoxy groups of 1 to 30 carbon atoms, which may contain a halogen atom, or hydroxyl or ether group, e.g., methoxy, ethoxy, hexyl, phenoxy, 2-fluoroethoxy and 2-methoxyethoxy; aromatic groups of 1 to 30 carbon atoms, which may contain a halogen atom, or hydroxyl or ether group, e.g., phenyl, naphthyl, 4-methylphenyl, 4-chlorophenyl, 4-methoxyphenyl, anthryl, hydroxyphenyl, fluorophenyl and hydroxynaphthyl; alkenyl groups of 1 to 30 carbon atoms, which may contain a halogen atom, or hydroxyl or ether group, e.g., vinyl, propenyl, 3-fluoro-1-propenyl and 3-methoxy-1-propenyl; and alkynyl groups of 1 to 30 carbon atoms, which may contain a halogen atom, or hydroxyl or ether group, e.g., ethynyl, propynyl, 3-fluoro-1-propynyl and 3-methoxy-1-propynyl.

Similarly, the divalent organic groups useful for the present invention include alkylene groups of 1 to 30 carbon atoms, which may contain a halogen atom or ether group, e.g., methylene, ethylene, propylene, hexamethylene, fluoroethylene and methyleneoxymethylene; alkenylene groups of 1 to 30 carbon atoms, which may contain a halogen atom or ether group, e.g., vinylene, propenylene, butenylene, hexenylene, 3-fluoropropenylene and propenyleneoxymethylene; alkynylene groups of 1 to 30 carbon atoms, which may contain a halogen atom or ether group, e.g., ethynylene, propynylene, butynylene, 3-fluoropropynylene and propynyleneoxymethylene; and divalent aromatic groups of 1 to 30 carbon atoms, which may contain a halogen atom or ether group, e.g., phenylene, naphthylene, anthrylene, biphenylene, fluorophenylene, phenyleneoxyphenylene and phenylenemethylenephenylene.

Those represented by R⁴ include alkyl groups of 1 to 30 carbon atoms, which may contain a halogen atom, or hydroxyl or ether group, e.g., methyl, ethyl, hexyl and fluoromethyl; alkenyl groups of 1 to 30 carbon atoms, which may contain a halogen atom, or hydroxyl or ether group, e.g., vinyl, propenyl, 3-fluoro-l-propenyl and 3-methoxy-1-propenyl; alkynyl groups of 1 to 30 carbon atoms, which may contain a halogen atom, or hydroxyl or ether group, e.g., ethynyl, propynyl, 3-fluoro-1-propynyl and 3-methoxy-1-propynyl; aromatic groups of 1 to 30 carbon atoms, which may contain a halogen atom, or hydroxyl or ether group, e.g., phenyl, naphthyl, anthryl, hydroxyphenyl, fluorophenyl, methylphenyl and hydroxynaphthyl; and hydrogen atom.

These examples are commonly applicable to the general formulae (2), (3), (4), (5) and (6).

The modified silicone compounds of the present invention having the Si—H bond and an unsaturated carbon-carbon bond include;

1) modified silicone compounds having the Si—H bond and the carbon-carbon triple bond, with R¹, R³ and k in the general formula being a monovalent organic group, —C≡C— and 1, respectively, and

2) modified silicone compounds having the Si—H bond and the carbon-carbon double bond, with —R³ and k in the general formula being —C(R⁷)═C(R⁸)— and 1, respectively.

More specifically, those represented by the general formulae (2), (3), (4), (5) and (6) are more preferable.

i) Modified silicone compounds represented by the general formula (2)

The above modified silicone compounds have the following structure (general formula (2)):

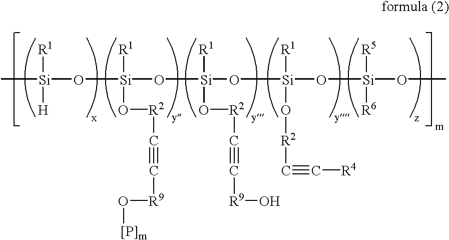

(wherein R¹ is a monovalent organic group; R², R⁴, R⁵ and R⁶ are the same as R², R⁴, R⁵ and R⁶ defined in (a); R⁹ is a divalent organic bond; x is more than 0 but less than 1; y″, y″′, y″″ and z are each 0 or more but less than 1, satisfying the relationship x+y″+y″′+y″″+z=1; y″ and y″′ are not 0 simultaneously; m is an integer of 3 or more; P is a composition of the polymer in the []ₘ; but constituent elements may be optionally arranged).

More specifically, those with a (poly)methylene group for R² and R⁹ are described, although the present invention is not limited thereto, where p and q are each an integer of 1 to 5, which may be the same or different.

The general formula (2) is reduced to the general formula (10), when each of y″ and y″′ is 0:

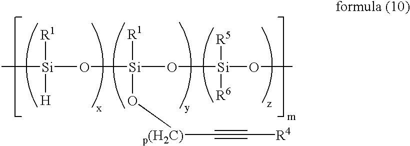

The general formula (2) is reduced to the general formula (11), when y″″ is 0:

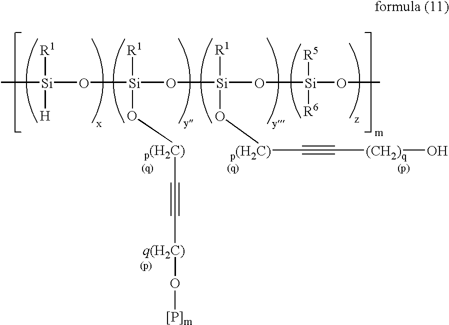

The general formula (2) is reduced to the general formula (12), when none of y′, y″′ and y″″ is 0:

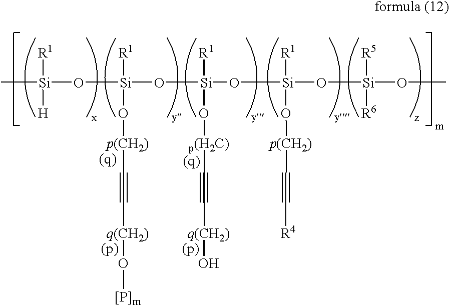

Those modified silicone compounds having a group other than (poly)methylene are also included in the present invention, needless to say.

The modified silicone compound can be produced by reacting an H-silicone represented by the general formula (7):

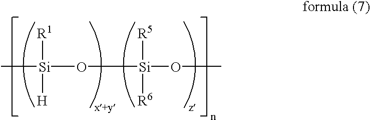

in a dehydrogenation manner with an alkynyl alcohol represented by HO—R²—C≡C—R⁴ and/or an alkynylenediol represented by HO—R²—C≡C—R⁹—OH.

The results of the synthetic reactions observed in EXAMPLES indicate that the alkynyloxy-substituted silicone produced had a larger molecular weight than expected from the starting compound, by which is meant that it contains structures produced by side-reactions, e.g., the reaction between the triple bond and Si—H bond, and recombination of the product, in addition to the dehydrogenation reaction.

Process of Producing the Modified Silicone Compound

The process of producing the modified silicone compound (2) is described. It is common to synthesis of the modified silicone compound having the Si—H bond of varying type with an alcohol compound, based on which various types of the modified silicone compounds can be produced. This process involves the following reaction A or B, depending on type of silicone having the Si—H bond:

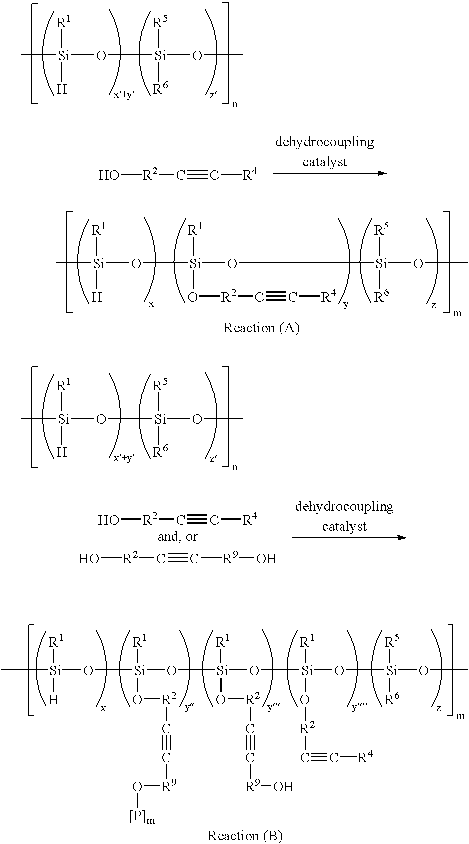

A siloxanes having the Si—H bond in various main chains is used as the H-silicone for the present invention. It may be cyclic. The H-silicones useful for the present invention include poly(methylsiloxane), poly[(methylsiloxane)(dimethylsiloxane)] copolymer, poly(ethylsiloxane), poly[(methylsiloxane)(phenylmethylsiloxane)] copolymer, poly[(methylsiloxane)(octylmethylsiloxane)] copolymer, trimethylcyclotrisiloxane, tetramethylcyclotetrasiloxane and tetramethylcyclotetrasiloxane.

In the alkynyl alcohol represented by HO—R—C≡C—R⁴ and the alkynylenediol represented by HO—R²—C≡C—R⁹—OH, R² and R⁹ are each a divalent organic group, and R⁴ is the monovalent organic group described earlier.

The alcohol compound having an ethynyl group and represented by HO—R²—C≡C—R⁴ is the other starting compound for the present invention. These compounds useful for the present invention include 2-propyn-1-ol, 2-butyn-1-ol, 3-butyn-1-ol, 3-butyn-2-ol, 1-fluoro-3-butyn-2-ol, 4-fluoro-2-butyn-1-ol, 2-oxa-3-butyn-1-ol, 5-oxa-2-hexyn-1-ol, 6-oxa-2-heptyn-1-ol, 2-butyn-1,4-diol, 4-pentyn-1-ol, 5-hexyn-1-ol, 2-hexyn-1-ol, 3-hexyn-1,6-diol, 7-octyn-1-ol, 2-octyn-1-ol, 3-hydroxy-1-propynylbenzene, 3-phenyl-2-propyn-1-ol, 4-penten-2-yn-1-ol, 1-fluoro-4-penten-2-yn-1-ol, 2-penten-4-yn-1-ol, 2-hexen-5-yn-1-ol, 2-hexen-4-yn-1-ol, 6-fluoro-4-hexen-2-yn-1-ol, 2-oxa-4-hepten-6-yn-1-ol, 7-oxa-4-octen-2-yn-1-ol, 5-hexen-2-yn-1-ol, 4-hexen-2-yn-1-ol, 2,4-pentadiyn-1-ol, 1-fluoro-2,4-pentadiyn-1-ol, 2,5-hexadiyn-1-ol, 6-fluoro-2,4-hexadiyn-1-ol, 2-oxa-4,6-heptadiyn-1-ol, 7-oxa-2,4-octadiyn-1-ol, 2-ethynylphenol, 3-ethynylphenol, 4-ethynylphenol, 3,5-diethynylphenol, 6-ethynyl-2-naphthol, 5-ethynyl-2-naphthol, 5-ethynylresorcinol, 4-ethynyl-41-hydroxybiphenyl, 10-ethynyl-9-anthrol, 3-hydroxy-5-ethynyltoluene, 3-ethynyl-5-fluoro-phenol, (4-ethynylphenyl)(4-hydroxyphenyl)ether, (4-ethynylphenyl) (4-hydroxyphenyl)methane, 4-(1-propynyl)phenol, 4-(1-propynyl)naphthol, 4-(1-butynyl)phenol, 4-(3-butenyl-1-ynyl)phenol, 4-(1,3-butadiynyl)phenol, 4-(1-pentynyl)phenol, 4-(1-hexynyl)phenol, 4-(1-octynyl)phenol, 4-(phenylethynyl)phenol, 4-naphthylethynylphenol and 1,2-bis(4-hydroxyphenyl)acetylene.

The general formula HO—R²—C≡C—R⁴ is reduced to the general formula (13), when R2 is a (poly)methylene:

R⁴—C≡C—(CH₂)ₚ—OH formula (13)

The alkynyl alcohols represented by the general formula (13) include propargyl alcohol, phenylpropargyl alcohol, 2-butyn-1-ol, 2-pentyn-1-ol, 3-butyn-1-ol, 3-pentyn-1-ol, 4-pentyn-1-ol, 2-hexyne-1-ol, 3-hexyne-1-ol and 5-hexyne-1-ol. The general formula HO—R²—C≡C—R⁹—OH for the alkynylenediols is reduced to the general formula (14), when R² and R⁹ are each a (poly)methylene:

HO—(CH₂)_{q}—C≡C—(CH₂)ₚ—OH formula (14)

The alkynylenediols represented by the general formula (14) include 1,4-butynylenediol, 1,6-hexynylenediol, 1,8-octynylenediol, 1,5-penta-3-ynediol and 6-hexa-3-ynediol.

A combination of the alkynyl alcohol and the alkynylenediol, mixed in an adequate ratio, may be used, as required, for specific purposes.

The alkynyloxy-substituted silicone of the present invention can be produced by reacting an H-silicone in a dehydrogenation manner with the alkynyl alcohol and/or the alkynylenediol.

The process of the present invention is described for production of the modified silicone compound represented by the general formula (2) by reacting a silicone polymer containing the Si—H group with the alkynyl alcohol and/or the alkynylenediol. The reaction system includes a feed supply unit, stirrer in the reactor and temperature controller for the reactor. The reaction may be effected in a solvent, or in the absence of a solvent. The stock compounds of a silicone polymer containing the Si—H group and represented by the general formula (7), the alkynyl alcohol represented by HO—R²—C≡C—R⁴ and/or the alkynylenediol, and dehydrocoupling catalyst are charged in the reactor, together with a solvent, as required. The dehydrocoupling catalyst may be charged in the form of solution or suspension, or directly without being dissolved in a solvent. The starting compounds are reacted with each other for a given time with stirring, while temperature of the reaction solution is controlled at a given level. Then, the solvent is removed by distillation under a vacuum or the polymer is separated out from the effluent, to produce the modified silicone compound.

The dehydrocoupling catalysts useful for the reaction (A) or (B) can be broadly classified into two general categories, transition metal complex and basic catalysts. The transition metal complex catalysts include copper-based catalysts of various copper salts, copper compounds, copper complexes and organocopper compounds. More specifically, they include phenyl copper (I), tetrakis(trimethylsilyl)methyltetracopper (I), cyclopentadienyl[bis(trimethylsilyl)acetylene]copper (I), trimethylphosphine(hexafluoroacetylacetonato)copper (I), butyl(tributylphosphine)copper (I), cyclopentadienyl(triethylphosphine)copper (I), cyclopentadienyl(triphenylphosphine)copper (I), pentamethylcyclopentadienyl(triethylphosphine)copper (I), tetrahydroboric acid bis(triphenylphosphine)copper (I), hydride(triphenylphosphine)copper (I), methylbis(triphenylphosphine)copper (I), chlorotris(triphenylphosphine)copper (I), tetrachlorotetrakis(triphenylphosphine)tetracopper (I), triphenylphosphinecopper hydride complex, nitoratobis(triphenylphosphine)copper (I) and copper hydride of triphenylphosphine (HCuPPh₃)₆, of which copper hydride of triphenylphosphine (HCuPPh₃)₆ is more preferable.

Compounds of a transition metal other than copper include sodium chloroplatinate, rhodium tris(triphenylphosphine) chloride, rhodium (II) acetate, rhodium (II) butyrate, rhodium (II) perfluorobutyrate, manganese tetracarbonyl bromide, manganese pentacarbonyl chloride, manganese pentacarbonyl bromide, pentacarbonyl manganese methylate, dichloropentadienyl dichlorozirconium, dicyclopentadienyl dimethyl zirconium, dipentamethylcyclopentadienyl dimethyl zirconium, dicyclopentadienyl diethyl zirconium and dicyclopentadienyl diphenyl zirconium.

The basic catalysts useful for the reaction (A) or (B) can be broadly classified into metal hydrides, e.g., the one which the inventors of the present invention have disclosed (Japanese Patent Laid-open Publication No. 10-120689), metallic compounds, e.g., the one which the inventors of the present invention have disclosed (Japanese Patent Laid-open Publication No. 11-158187), and typical elementary metals. Refer to the related patent publications for the specific compounds and directions for use, which are described in the claims, examples and preferred embodiments.

The typical elementary metals include lithium, sodium, potassium, rubidium and cesium (Group 1 metals in Periodic Table), and beryllium, magnesium, calcium, strontium and barium (Group 2 metals).

These metals may be used directly, but preferably after being divided into fine particles to activate them, in particular for the typical Group 2 metals. The methods for producing the activated fine metallic particles include reduction of the metal halides by a lithium/aromatic complex (H. Xiong and R. D. Rieke, Journal of Organic Chemistry, Vol. 54, 3247-3249 (1989); T. Wu, H. Xiong and R. D. Rieke, Journal of Organic Chemistry, Vol. 55, 5045-5051 (1990); and A. Yanagisawa, S. Habaue, K. Yasue and H. Yamamoto, Journal of American Chemical Society, Vol. 116, 6130-6141 (1994)), reduction of the metal halides by potassium, and simultaneous condensation of the metal vapor and solvent (K. J. Klabunde, H. F. Efner, L. Satek and W. Donley, Journal of Organometallic Chemistry, Vol. 71, 309-313 (1974)). Refer to the above publications for the specific compounds to be used.

A ratio of the silicone polymer containing the Si—H group and represented by the general formula (7) to the alkynyl alcohol and/or the alkynylenediol in the starting mixture is not limited. However, the latter compound(s) are preferably used at 1 to 1000 mmols per 100 mmols of the Si—H bond in the former, more preferably 10 to 100 mmols. The transition metal complex catalysts and basic catalysts may be used either individually or in combination. The catalyst is dosed at 0.0001 to 200 mmols per 100 mmols of the alkynyl alcohol and/or the alkynylenediol, preferably 0.01 to 10 mmols.

The molar ratio of the catalyst for the present invention to the alkynyl alcohol and/or the alkynylenediol may be optionally set at a level in a range from 1:1 to 1:100,000, preferably 1:2 to 1:10,000.

The reactor is preferably purged with an inert gas, e.g., high-purity nitrogen or argon gas. The solvents useful for the present invention include aromatic hydrocarbon-based ones, e.g., benzene, toluene, xylene, ethyl benzene and mesitylene; ether-based ones, e.g., diethyl ether, n-butyl ether, anisole, diphenyl ether, tetrahydrofuran, dioxane, bis(2-methoxyethyl) ether and 1,2-bis(2-methoxyethoxy)ethane; halogen-containing ones, e.g., dichloromethane and chloroform; organic polar ones, e.g., N-methyl pyrrolidone, dimethyl formamide and dimethyl acetoamide; and a mixture thereof. Quantity of the solvent is preferably in a range from 0.1 to 40 mL per 1 mmol of the ethynyl-containing alcohol as the starting compound. The solvent is preferably dehydrated and dried beforehand, because moisture in the solvent may deactivate the catalyst.

Reaction temperature is in a range from −50 to 300° C., preferably 0 to 150° C. Reaction pressure may be normal or elevated pressure. It is however preferably elevated when reaction temperature is above boiling point of the solvent, and in this case a pressure vessel is used for the reactor. Reaction time varies with operating conditions such as temperature, but is adequate at 0.1 to 200 hours.

Isolation of the modified silicone compound by, e.g., removing the solvent, may be conducted for the as-received reaction effluent solution. However, it is preferable to treat the effluent solution beforehand by dispersion in a saturated aliphatic hydrocarbon, filtration and treatment with an aqueous solution (Japanese Patent Laid-open Publication No. 11-236388) or treatment by a cation-exchanging resin to remove the catalyst.

The saturated aliphatic hydrocarbons useful for removing the catalyst include pentane, hexane, heptane and octane. It is used at 0.01 to 1000 mL per 1 g of the silicone polymer containing the SiH bond, preferably 0.1 to 100 mL.

Removal of the catalyst by a cation-exchanging resin may be effected by treating the reaction effluent solution by the contact filtration or fixed-bed method. More specifically, the reaction effluent is mixed with a cation-exchanging resin and stirred for a given time, and the mixture is filtered to remove the resin in the former, whereas the reaction effluent is passed over an H type cation-exchanging resin in a fixed bed, e.g., column or fixed-bed tower, in the latter. The reaction effluent solution is normally treated once, but may be treated 2 to 100 times. Normally, the as-received reaction effluent solution is treated, but it may be diluted 1.1 to 100 times beforehand with a solvent.

The cation-exchanging resins useful for the present invention include a strongly acidic, H type cation-exchanging resin with sulfone group as the exchanging group, and weakly acidic H type cation-exchanging resin with carboxyl, phenol or phosphine group as the exchanging group, where the resin may be carried by silica, alumina or the like. These resins may be used either individually or in combination. The resin may be granular or powdery. The cation-exchanging resin containing moisture at above 10% by weight may be used directly, but preferably pre-treated by drying by hot wind, or under heating or a vacuum to reduce the moisture content to 10% by weight or less.

Quantity of the cation-exchanging resin varies depending on its type and exchanging capacity, catalyst type used, and catalyst quantity in the reaction effluent solution, but is in a range from 0.0001 to 10 g per 1 mL of the solution. Treatment or residence time varies depending on type and quantity of the cation-exchanging resin used, and catalyst quantity in the reaction effluent solution, but is in a range from 0.001 to 400 hours. Treatment temperature is in a range from −50 to 300° C., preferably 0 to 150° C.

The reaction effluent solution is treated, after the catalyst is removed, by removing the solvent, column separation or precipitation to isolate the modified silicone compound therefrom.

A molar ratio of the OH group in the alkynyl alcohol and/or the alkynylenediol as the starting compounds for the present invention to the Si—H group in the H-silicone also as the starting compound for the present invention may be optionally selected. At a molar ratio of 1 or less, part of the Si—H group in the H-silicone is substituted by the alkynyloxy group, leaving the alkynyloxy-substituted silicone containing part of the Si—H group. In order to produce the alkynyloxy-substituted silicone with the Si—H group in the H-silicone totally substituted by alkynyloxy group, the alkynyl alcohol and/or the alkynylenediol should be used at least at an equivalent to the Si—H group in the H-silicone.

Molecular weight of the alkynyl-substituted silicone obtained by the present invention is not limited, but is normally in a range from 200 to 5,000,000, determined by gel permeation chromatography (GPC), preferably 1,000 to 5,000,000, more preferably 1,000 to 500,000 or so. Molecular weight of the alkynyl-substituted silicone of the present invention cannot be determined in some cases, because it contains a polymer of crosslinked structure.

ii) Modified Silicone Compound Represented by the General Formula (3)

The modified silicone compound represented by the general formula (3) is the compound having the Si—H bond and the carbon-carbon triple bond.

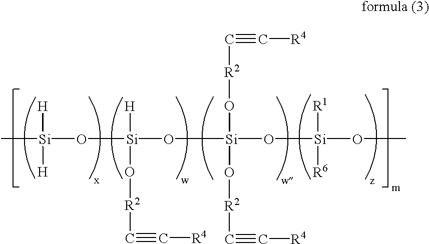

The novel compound of the present invention, represented by the general formula (3), can be produced by reacting a silicone polymer containing the Si—H bond, represented by the general formula (8), with an alkynyl alcohol represented by HO—R²—C≡C—R⁴ in the presence of a dehydrocoupling catalyst through the dehydrocoupling reaction (C):

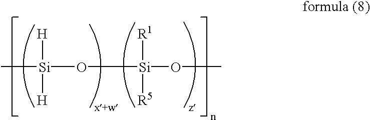

The alkynyl alcohol for the above reaction can be suitably selected from those described in “Process of producing the modified silicone compound,” described earlier.

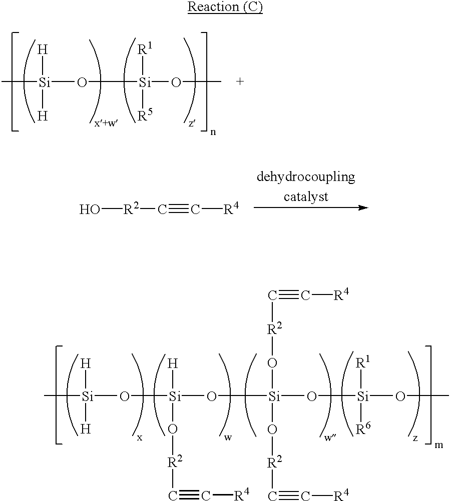

The silicone polymer containing the Si—H bond, represented by the general formula (8), is one of the starting compounds for the present invention. These compounds useful for the present invention include poly(dihydrogen siloxane), poly[(dihydrogen siloxane)(dimethylsiloxane)] copolymer, poly[(dihydrogen siloxane)(methyl hydrogen siloxane)] copolymer, poly[(dihydrogen siloxane)(phenyl hydrogen siloxane)] copolymer, poly[(dihydrogen siloxane)(diethylsiloxane)] copolymer, poly[(dihydrogen siloxane)(diisopropylsiloxane)] copolymer, poly[(dihydrogen siloxane)(dihexylsiloxane)] copolymer, poly[(dihydrogen siloxane)(dioctylsiloxane)] copolymer, poly[(dihydrogen siloxane)(diphenylsiloxane)] copolymer, poly[(dihydrogen siloxane)(ethylmethylsiloxane)] copolymer, poly[(dihydrogen siloxane)(hexylmethylsiloxane)] copolymer, poly[(dihydrogen siloxane)(octylmethylsiloxane)] copolymer, poly[(dihydrogen siloxane)(octadecylmethylsiloxane)] copolymer, poly[(dihydrogen siloxane)(phenylmethylsiloxane)] copolymer, poly[(dihydrogen siloxane)(diethoxysiloxane)] copolymer, poly[(dihydrogen siloxane)(dimethoxysiloxane)] copolymer, poly[(dihydrogen siloxane)(ethoxymethylsiloxane)] copolymer, poly[(dihydrogen siloxane)(3,3,3-trifluoropropylmethylsiloxane)] copolymer, poly[(dihydrogen siloxane)(2-fluoroethoxymethylsiloxane)] copolymer, poly[(dihydrogen siloxane)((2-methoxyethoxy)methylsiloxane)] copolymer, poly[(dihydrogen siloxane)(phenoxymethylsiloxane)] copolymer, poly[(dihydrogen siloxane)(naphthylmethylsiloxane)] copolymer, poly[(dihydrogen siloxane)((4-chlorophenyl)methylsiloxane)] copolymer and poly[(dihydrogen siloxane)((4-methoxyphenyl)methylsiloxane)] copolymer.

The alcohol compound having an ethynyl group and represented by HO—R²—C≡C—R⁴ is the other starting compound for the present invention. These compounds useful for the present invention include 2-propyn-1-ol, 2-butyn-1-ol, 3-butyn-1-ol, 3-butyn-2-ol, 1-fluoro-3-butyn-2-ol, 4-fluoro-2-butyn-1-ol, 2-oxa-3-butyn-1-ol, 5-oxa-2-hexyn-1-ol, 6-oxa-2-heptyn-1-ol, 2-butyn-1,4-diol, 4-pentyn-1-ol, 5-hexyn-1-ol, 2-hexyn-1-ol, 3-hexyn-1,6-diol, 7-octyn-1-ol, 2-octyn-1-ol, 3-hydroxy-1-propynylbenzene, 3-phenyl-2-propyn-1-ol, 4-penten-2-yn-1-ol, 1-fluoro-4-penten-2-yn-1-ol, 2-penten-4-yn-1-ol, 2-hexen-5-yn-1-ol, 2-hexen-4-yn-1-ol, 6-fluoro-4-hexen-2-yn-1-ol, 2-oxa-4-hepten-6-yn-1-ol, 7-oxa-4-octen-2-yn-1-ol, 5-hexen-2-yn-1-ol, 4-hexen-2-yn-1-ol, 2,4-pentadiyn-1-ol, 1-fluoro-2,4-pentadiyn-1-ol, 2,5-hexadiyn-1-ol, 6-fluoro-2,4-hexadiyn-1-ol, 2-oxa-4,6-heptadiyn-1-ol, 7-oxa-2,4-octadiyn-1-ol, 2-ethynylphenol, 3-ethynylphenol, 4-ethynylphenol, 3,5-diethynylphenol, 6-ethynyl-2-naphthol, 5-ethynyl-2-naphthol, 5-ethynylresorcinol, 4-ethynyl-4′-hydroxybiphenyl, 10-ethynyl-9-anthrol, 3-hydroxy-5-ethynyltoluene, 3-ethynyl-5-fluoro-phenol, (4-ethynylphenyl)(hydroxyphenyl) ether, (4-ethynylphenyl)(hydroxyphenyl)methane, 4-(1-propynyl)phenol, 4-(1-propynyl)naphthol, 4-(1-butynyl)phenol, 4-(3-butenyl-1-ynyl)phenol, 4-(1,3-butadiynyl)phenol, 4-(1-pentynyl)phenol, 4-(1-hexynyl)phenol, 4-(1-octynyl)phenol, 4-(phenylethynyl)phenol, 4-naphthylethynylphenol and 1,2-bis(4-hydroxyphenyl)acetylene.

The modified silicone compound represented by general formula (3) from a silicone polymer containing the Si—H-bond and alkynyl alcohol compound can be produced by the process described in “Process of producing the modified silicone compound” described earlier using the silicone polymer containing the Si—H bond, represented by the general formula (8).

Process of Producing the Silicone Polymer Containing the Si—H Bond, Represented by the General Formula (8)

Next, the process of producing the silicone polymer containing the Si—H bond as the starting compound for the modified silicone compound is described. This process involves hydrolysis and condensation of H₂SiCl₂ only or its mixture with a dichlorosilane compound represented by R⁵(R¹)SiCl₂ into an H type silicone oligomer, and converts the oligomer into the silicone polymer containing the Si—H bond by the equilibrium reaction in the presence of an acid catalyst.

The dichlorosilane compounds represented by R⁵(R¹)SiCl₂, useful as the starting compounds for the present invention, include dimethyldichlorosilane, diethyldichlorosilane, diisopropyldichlorosilane, dihexyldichlorosilane, dioctyldichlorosilane, diphenyldichlorosilane, methylethyldichlorosilane, methylhexyldichlorosilane, methyloctyldichlorosilane, methyloctadecyldichlorosilane, methylphenyldichlorosilane, 3,3,3-trifluoropropylmethyldichlorosilane, diethoxydichlorosilane, dimethoxydichlorosilane and ethoxymethyldichlorosilane. A ratio of the dichlorosilane to H₂SiCl₂ is 0.1 to 10,000 mols versus 100100 mols, preferably 1 to 1000 mols. The reaction system includes a feed supply unit, stirrer in the reactor and temperature controller for the reactor. It is preferable for the reaction to first charge water and/or ice in the reactor, and then add H₂SiCl₂ and a dichlorosilane compound represented by R⁵(R¹)SiCl₂ dropwise. Conversely, H₂SiCl₂ and the other dichlorosilane compound may be charged first, to which water is added dropwise. Water is preferably neutral or acidic, and added preferably at 0.1 to 1000 mL per 1 mmol of the dichlorosilanes. H₂SiCl₂ and the other dichlorosilane compound may be directly charged dropwise, but preferably after being dissolved in a solvent. The solvents useful for the present invention include aromatic hydrocarbon-based ones, e.g., benzene, toluene and xylene; ether-based ones, e.g., diethyl ether, n-butyl ether, anisole, diphenyl ether, tetrahydrofuran, dioxane, bis(2-methoxyethyl) ether and 1,2-bis(2-methoxyethoxy)ethane; halogen-containing solvents, e.g., dichloromethane and chloroform; and saturated aliphatic hydrocarbon-based ones, e.g., hexane, heptane and octane. Quantity of the solvent is preferably in a range from 0.1 to 1000 mL per 1 mmol of H₂SiCl₂.

H₂SiCl₂ and the other dichlorosilane compound are added dropwise with stirring, while the reaction solution is controlled at a given temperature, to be hydrolyzed. After a lapse of a given time, the reaction effluent solution is treated to extract the resultant H type silicone oligomer in the presence of an extractant, as required. The extractants useful for the present invention include saturated hydrocarbon solvents, e.g., hexane, heptane and octane; aromatic hydrocarbon-based ones, e.g., benzene, toluene and xylene; ether-based ones e.g., diethyl ether, n-butyl ether, anisole, diphenyl ether, tetrahydrofuran, dioxane, bis(2-methoxyethyl) ether and 1,2-bis(2-methoxyethoxy)ethane; and halogen-containing ones, e.g., dichloromethane and chloroform. The reaction effluent solution is refined by drying under a vacuum to remove the solvent, column separation and distillation, to produce the H-type silicone oligomer.

Reaction temperature is in a range from −80 to 200° C., preferably −50 to 100° C. Reaction pressure may be normal or elevated pressure. It is however preferably elevated when reaction temperature is above boiling point of the solvent, and in this case a pressure vessel is used for the reactor. Reaction time varies with operating conditions such as temperature, but is adequate at 0.1 to 200 hours.

The resultant H type silicone oligomer may be directly charged in the reactor as the silicone polymer containing the Si—H bond for dehydrocoupling, but is preferably subjected to the equilibrium reaction step in the presence of an acidic catalyst to adjust its molecular weight. Its weight-average molecular weight is preferably in a range from 1,000 to 100,000.

The reaction system for the equilibrium reaction includes a feed supply unit, stirrer in the reactor and temperature controller for the reactor. An acidic catalyst, the H type silicone and, as required, solvent and/or disiloxane compound are charged in the reactor, and stirred at a given temperature for a given time. On completion of the reaction step, the effluent solution is treated, after being incorporated with water as required, to remove the catalyst by filtration, two-phase separation or the like. It is then treated by removing the solvent, column separation or precipitation to isolate the resultant silicone polymer containing the Si—H bond.

A disiloxane compound may be incorporated, as required, for the above reaction step. The disiloxane compounds useful for the present invention include hexamethyldisiloxane, hexaethyldisiloxane, hexapropyldisiloxane, hexahexyldisiloxane, hexaoctyldisiloxane, hexaphenyldisiloxane, diphenyltetramethyldisiloxane and dihydrogen tetramethyldisiloxane. Quantity of the disiloxane compound to be used varies depending on type and molecular weight of the H type silicone oligomer, and type and quantity of the catalyst used, but is in a range from 0.0001 to 100 g per 100 g of the H type silicone oligomer.

The acidic catalysts useful for the equilibrium reaction step include sulfuric acid, hydrochloric acid, nitric acid, phosphoric acid, acidic clay, iron chloride, boric acid and trifluoroacetic acid. Quantity of the catalyst to be used varies depending on type of acid, molecular weight of the oligomer and quantity of the solvent used, but is in a range from 0.0001 to 100 g per 1 g of the H type silicone oligomer.

The solvents useful for the present invention include saturated hydrocarbon-based ones, e.g., hexane, heptane and octane; aromatic hydrocarbon-based ones, e.g., benzene, toluene and xylene; ether-based ones e.g., diethyl ether, n-butyl ether, anisole, diphenyl ether, tetrahydrofuran, dioxane, bis(2-methoxyethyl) ether and 1,2-bis(2-methoxyethoxy)ethane; and halogen-containing ones, e.g., dichloromethane and chloroform. Quantity of the solvent to be used varies depending on type of the solvent, H-type silicone oligomer and acidic catalyst, but is in a range from 0.1 to 100 mL per 1 g of the H type silicone oligomer.

Reaction temperature is in a range from −80 to 200° C., preferably −50 to 100° C. Reaction pressure may be normal or elevated pressure. It is however preferably elevated when reaction temperature is above boiling point of the solvent, and in this case a pressure vessel is used for the reactor. Reaction time varies with operating conditions such as temperature, but is adequate at 0.1 to 200 hours.

The H-type silicone compound described above is also commercially available.

The modified silicone compound represented by the general formula (3) can be used as the cured product, after being set by the procedure described earlier in the description of the general formula (2).

iii) Modified Silicone Compound Represented by the General Formula (4)

The modified silicone compound, represented by the general formula (4)

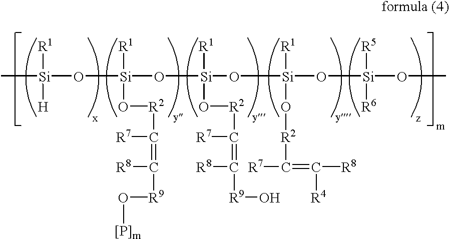

is produced by reacting an H-silicone represented by the general formula (7) in a dehydrogenation manner with an alkenyl alcohol represented by HO—R²—C(R⁷)═C(R⁸)—R⁴ and/or an alkenylenediol represented by HO—R²—C(R⁷)═C(R⁸)—R⁹—OH.

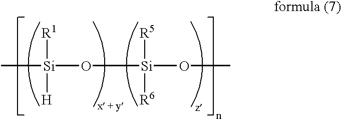

The H-silicone represented by the general formula (7) may be selected from those described earlier.

The symbols R², R⁴, R⁷, R⁸ and R⁹ in the formula HO-R²—C(R⁷)═C(R⁸)—R⁴ for the alkenyl alcohol and HO—R²—C(R⁷)═C(R⁸)—R⁹—OH for the alkenylenediol may be selected from those defined and described earlier, as required.

The modified silicone compound represented by the general formula (4) can be produced by reacting a silicone compound containing the Si—H bond with an alkenyl alcohol represented by HO—R²—C(R⁷)═C(R⁸)—R⁴ and/or an alkenylenediol represented by HO—R²—C(R⁷)═C(R⁸)—R⁹—OH in accordance with the process described in “process of producing the modified silicone compound” through the following reaction (D) or (E).

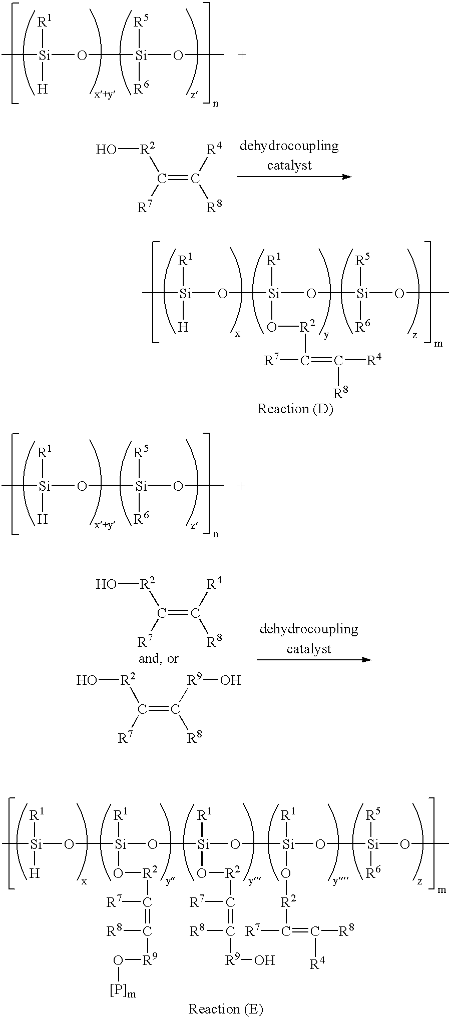

The alkenyl alcohols represented by HO—R C(R⁷)═C(R⁸)—R⁴, useful as the starting compound for the above reactions, include allyl alcohol, 1-buten-4-ol, 1-buten-3-ol, 2-buten-1-ol, 2-methyl-1-buten-2-ol, 1-penten-5-ol, 2-penten-5-ol, 1-hexen-5-ol, 1-hexen-6-ol, 1-octen-8-ol, 3-methyl-2-propen-1-ol, styryl carbinol, 2-methyl-2-buten-1-ol, 3-methyl-2-buten-1-ol, 2,3-dimethyl-2-buten-1-ol, 1,3-pentadien-5-ol, 1,4-pentadien-3-ol, 1,3-hexadien-6-ol, 2,4-hexadien-1-ol, 3-cyclohexenol, 2-vinyl phenol, 2-vinyl phenol, 3-vinyl phenol, 4-vinyl phenol, 3-fluoro-5-vinyl phenol, 3-allyl phenol, 4-allyl phenol, 3,5-diallyl phenol, 3-isopropenyl phenol, 4-isopropenyl phenol, 3-vinyl benzyl alcohol, 4-vinyl benzyl alcohol, 3-hydroxystyrene, 4-hydroxystyrene, 3-vinyl-8-naphthol, 9-vinyl-10-anthrol and 4-vinyl-4-biphenol.

Similarly, the alkenylenediols represented by HO—R²—C(R⁷)═C(R⁸)—R⁹—OH include 1,4-butendiol, 3,4-hydroxy-1-butene, 3-methylene-1,3-propanediol, 5-hexene-1,2-diol, 7-octene-1,2-propanediol, 2-methyl-1,4-butendiol, 2-phenyl-1,4-butendiol, 2,3-dimethyl-1,4-butendiol, 2,3-diphenyl-1,4-butendiol, 3-hexene-1,5-diol, 1,5-hexadiene-3,4-diol, 3,4-hexadiene-1,5-diol, 4-cyclopentene-1,3-diol, 1,2-dihydrocatechol, 2,5-diallyl benzene-1,4-diol, 3-vinyl resorcinol, 3-vinyl catechol, 2-vinyl hydroquinone, 3-allyl resorcinol, 4,4′-dihydroxystilbene and 4′-vinyl-3,5-dihydroxybiphenyl.

The modified silicone compound of the present invention can be set to produce the cured product in accordance with “process of setting the modified silicone compound and cured product thereof,” described later.

iv) Modified Silicone Compound Represented by the General Formula (5)

The modified silicone compound represented by the general formula (5)

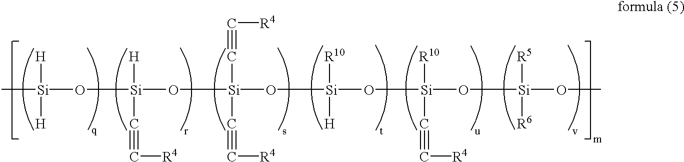

(wherein the symbols are the same as those for the general formula (5) described earlier) can be produced by reacting an H type silicone, represented by the general formula (9), with an ethynyl-containing compound resented by R⁴—C≡C—H in the presence of a dehydrocoupling catalyst through the following reaction (F):

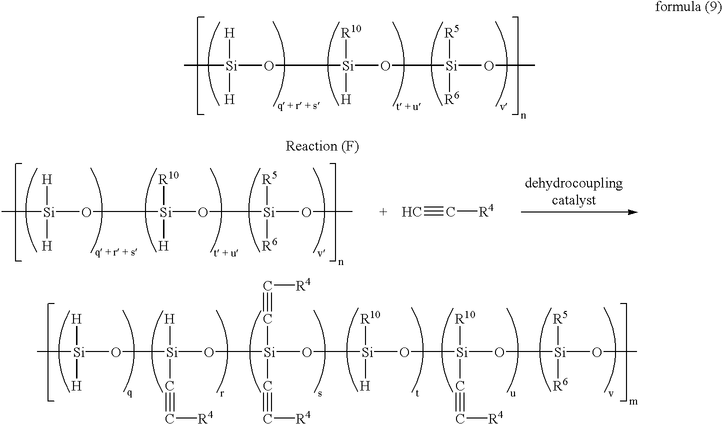

The silicone polymers containing the Si—H bond, represented by the general formula (9) include poly(dihydrogen siloxane), poly(methylhydrogen siloxane), poly(ethylhydrogen siloxane), poly(phenylhydrogen siloxane), poly[(methylhydrogen siloxane)(dimethylsiloxane)] copolymer, poly[(methylhydrogen siloxane)(ethylmethylsiloxane)] copolymer, poly[(methylhydrogen siloxane)(diethylsiloxane)] copolymer, poly[(methylhydrogen siloxane)(hexylmethylsiloxane)] copolymer, poly[(methylhydrogen siloxane)(octylmethylsiloxane)] copolymer, poly[(methylhydrogen siloxane)(octadecylmethylsiloxane)] copolymer, poly[(methylhydrogen siloxane)(phenylmethylsiloxane)] copolymer, poly[(methylhydrogen siloxane)(diethoxysiloxane)] copolymer, poly[(methylhydrogen siloxane)(dimethoxysiloxane)] copolymer, poly[(methylhydrogen siloxane)(3,3,3-fluoropropylmethylsiloxane)] copolymer, poly[(dihydrogen siloxane)(2-fluoroethoxymethylsiloxane)] copolymer, poly[(dihydrogen siloxane)((2-methoxyethoxy)methylsiloxane)] copolymer, poly[(dihydrogen siloxane)(phenoxymethylsiloxane)] copolymer, poly[(dihydrogen siloxane)(naphthylmethylsiloxane)] copolymer, poly[(dihydrogen siloxane)((4-chlorophenyl)methylsiloxane)] copolymer and poly[(dihydrogen siloxane)((4-methoxyphenyl)methylsiloxane)] copolymer.

The ethynyl-containing compound represented by R⁴—C≡CH is the other starting compound for the present invention. These compounds useful for the present invention include acetylene, propyne, 3-fluoro-1-propyne, 1-butyne, 1-pentyne, 1-hexyne, 5-oxa-1-hexyne, 1-octyne, 2-propyn-1-ol, 1-methoxy-2-propyne, 1-butene-3-yne, 1-pentene-4-yne, 2-pentene-4-yne, 1-fluoro-2-pentene-4-yne, 1-hexene-5-yne, 6-oxa-3-heptene-1-yne, 2-octene-7-yne, 1,3-butadiyne, 1,3-pentadiyne, 5-fluoro-1,3-pentadiyne, 6-oxa-1,3-heptadiyne, 1,4-pentadiyne, 1,5-hexadiyne, 1,3-hexadiyne, 1,7-octadiyne, phenylacetylene, p-diethynylbenzene, m-diethynylbenzene, 3-ethynylphenol, 4-ethynylphenol, 2-ethynylnaphthalene, 3-ethynylnaphthol, 6-ethynyl-2-naphthol, 5-ethynyl-2-naphthol, 4-ethynylbiphenyl, 9-ethynylanthracene, 4-ethynyltoluene, 3-hydroxy-5-ethynyltoluene, 4-fluorophenylacetylene, 4-chlorophenylacetylene, 4-methoxyphenylacetylene, (4-ethynylphenyl)(phenyl) ether, (4-ethynylphenyl)(phenyl)methane, 2-propynylbenzene and 4-phenyl-3-butenyl-1-yne.

Next, the process of producing the modified silicone compound represented by the general formula (9) from a silicone polymer containing the Si—H bond and ethynyl-containing compound is described. The reaction system includes a feed supply unit, stirrer in the reactor and temperature controller for the reactor. The reaction may be effected in a solvent, or in the absence of a solvent. The stock compounds of a silicone polymer containing the Si—H group and represented by the general formula (9), ethynyl-containing compound represented by HC≡C—R⁴, and dehydrocoupling catalyst are charged in the reactor, together with a solvent, as required. The dehydrocoupling catalyst may be charged in the form of solution or suspension, or directly without being dissolved in a solvent. The starting compounds are reacted with each other for a given time with stirring, while temperature of the reaction solution is controlled at a given level. Then, the solvent is removed by distillation under a vacuum or the polymer is separated out from the effluent, to produce the modified silicone compound.

The dehydrocoupling catalysts useful for the reaction (F) can be broadly classified into two general categories, transition metal complex and basic catalysts. The transition metal complex catalysts which can be used for the reaction (F) include CuCl/amine, CuBr/amine, CuI/amine, [IrH(H₂O)(bq)PPh₃]SbF₆, IrH₂(SiEt₃)(COD)AsPh₃], Ir(OMe)(COD)₂, Ir₄(CO)₁₂—PPh₃, Yb(Ph₂CNPh)-HMPA, H₂PtCl₆/LiI—I₂ and RhCl(PPh₃)₃, wherein bq is benzoquinolinate and COD is cyclooctadiene.

The basic catalysts useful for the reaction (F) can be broadly classified into basic oxides, metal hydrides and metallic compounds, e.g., those which the inventors of the present invention have disclosed in the claims and description in the patent publications, Japanese Patent Laid-open Publication Nos. 7-90085, 10-120689 and 11-158187, respectively, and typical elementary metals.

The typical elementary metals include lithium, sodium, potassium, rubidium and cesium (Group 1 metals in Periodic Table), and beryllium, magnesium, calcium, strontium and barium (Group 2 metals).

These metals may be used directly, but preferably after being divided into fine particles to activate them, in particular for the typical Group 2 metals. The methods for producing the activated fine metallic particles include reduction of the metal halides by a lithium/aromatic complex (H. Xiong and R. D. Rieke, Journal of Organic Chemistry, Vol. 54, 3247-3249 (1989); T. Wu, H. Xiong and R. D. Rieke, Journal of Organic Chemistry, Vol. 55, 5045-5051 (1990); and A. Yanagisawa, S. Habaue, K. Yasue and H. Yamamoto, Journal of American Chemical Society, Vol. 116, 6130-6141 (1994)), reduction of the metal halides by potassium (T. P. Burns and R. D. Rieke, Journal of Organic Chemistry, Vol. 52, 3647-3680 (1987), and simultaneous condensation of the metal vapor and solvent (K. J. Klabunde, H. F. Efner, L. Satek and W. Donley, Journal of Organometallic Chemistry, Vol. 71, 309-313 (1974)).

A ratio of the silicone polymer containing the Si—H group and represented by the general formula (9) to the ethynyl-containing compound is not limited. However, the latter compound is preferably used at 1 to 500 mmols per 100 mmols of the Si—H bond in the former, more preferably 10 to 100 mmols. The transition metal complex catalysts and basic catalysts may be used either individually or in combination. The catalyst is dosed at 0.0001 to 200 mmols per 100 mmols of the ethynyl-containing compound, preferably 0.01 to 10 mmols.

The reactor is preferably purged with an inert gas, e.g., high-purity nitrogen or argon gas. The solvents useful for the present invention include aromatic hydrocarbon-based ones, e.g., benzene, toluene, xylene, ethyl benzene and mesitylene; ether-based solvents, e.g., diethyl ether, n-butyl ether, anisole, diphenyl ether, tetrahydrofuran, dioxane, bis(2-methoxyethyl) ether and 1,2-bis(2-methoxyethoxy)ethane; halogen-containing ones, e.g., dichloromethane and chloroform; organic polar ones, e.g., N-methyl pyrrolidone, dimethyl formamide and dimethyl acetoamide; and a mixture thereof. Quantity of the solvent is preferably in a range from 0.1 to 40 mL per 1 mmol of the ethynyl-containing compound as the starting compound. The solvent is preferably dehydrated and dried beforehand, because moisture in the solvent may deactivate the catalyst.

Reaction temperature is in a range from −50 to 300° C., preferably 0 to 150° C. Reaction pressure may be normal or elevated pressure. It is however preferably elevated when reaction temperature is above boiling point of the solvent, and in this case a pressure vessel is used for the reactor. Reaction time varies with operating conditions such as temperature, but is adequate at 0.1 to 200 hours.

Isolation of the modified silicone compound by removing the solvent may be conducted for the as-received reaction effluent solution. However, it is preferable to treat the effluent solution beforehand by dispersion in a saturated aliphatic hydrocarbon, filtration and treatment with an aqueous solution (Japanese Patent Laid-open Publication No. 11-236388) or treatment by a cation-exchanging resin to remove the catalyst.

The saturated aliphatic hydrocarbons useful for removing the catalyst include pentane, hexane, heptane and octane. It is used at 0.01 to 200 mL per 1 g of the silicone polymer containing the SiH bond, preferably 0.1 to 50 mL.

Removal of the catalyst by a cation-exchanging resin may be effected by treating the reaction effluent solution by the contact filtration or fixed-bed method. More specifically, the reaction effluent is mixed with a cation-exchanging resin and stirred for a given time, and the mixture is filtered to remove the resin in the former, whereas the reaction effluent is passed over an H type cation-exchanging resin in a fixed bed, e.g., column or fixed-bed tower, in the latter. The reaction effluent solution is normally treated once, but may be treated 2 to 100 times. Normally, the as-received reaction effluent solution is treated, but it may be diluted 1.1 to 100 times beforehand with a solvent.

The cation-exchanging resins useful for the present invention include a strongly acidic, H type cation-exchanging resin with sulfone group as the exchanging group, and weakly acidic H type cation-exchanging resin with carboxyl, phenol or phosphine group as the exchanging group, where the resin may be carried by silica, alumina or the like. These resins may be used either individually or in combination. The resin may be granular or powdery. The cation-exchanging resin containing moisture at above 10% by weight may be used directly, but preferably pre-treated by drying by hot wind, or under heating or a vacuum to reduce the moisture content to 10% by weight or less.

Quantity of the cation-exchanging resin varies depending on its type and exchanging capacity, catalyst type used, and catalyst quantity in the reaction effluent solution, but is in a range from 0.0001 to 10 g per 1 mL of the solution. Treatment or residence time varies depending on type and quantity of the cation-exchanging resin used, and catalyst quantity in the reaction effluent solution, but is in a range from 0.001 to 400 hours. Treatment temperature is in a range from −50 to 300° C., preferably 0 to 150° C.

The reaction effluent solution is treated, after the catalyst is removed, by removing the solvent, column separation or precipitation to isolate the modified silicone compound therefrom.

Weight-average molecular weight of the modified silicone compound thus produced is preferably 500 to 1,000,000, more preferably 1,000 to 100,000.

(v) Modified Silicone Compound Represented by the General Formula (6)

The modified silicone compound represented by the general formula (6) has the following structure:

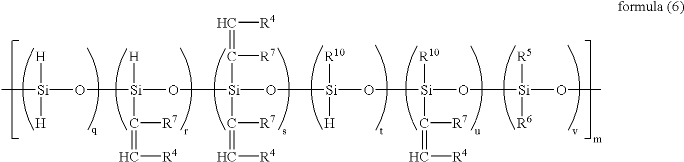

(wherein the symbols are the same as those for the general formula (6) described earlier).

The silicone polymer containing the Si—H bond, which is used as one of the starting compounds and represented by the general formula (9), is selected from those described in (iv).

The modified silicone compound represented by the general formula (6) can be produced by reacting the compound represented by the general formula (9) with a compound represented by R⁴—C≡C—R⁵ through the following reaction (G):

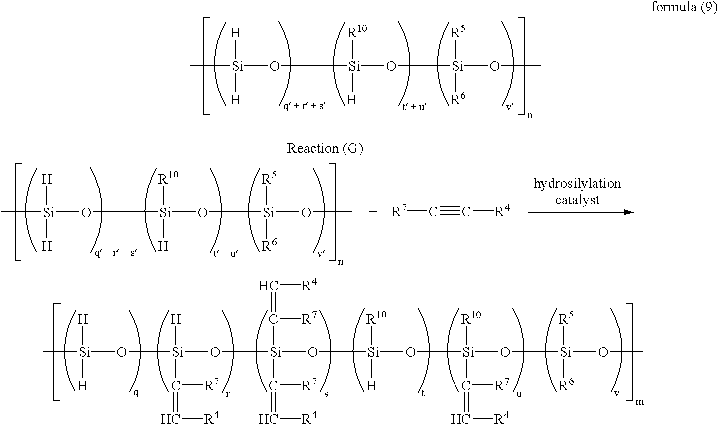

The ethynyl-containing compounds useful for the other starting compound and represented by R⁴—C≡C—R⁵ include propyne, 3-fluoro-1-propyne, 1-butyne, 2-butyne, 1-pentyne, 1-hexyne, 5-oxa-1-hexyne, 1-octyne, 3-octyne, 1-butene-3-yne, 1-pentene-4-yne, 2-pentene-4-yne, 1-pentene-3-yne, 1-fluoro-2-pentene-4-yne, 1-hexene-5-yne, 1-hexene-4-yne, 6-oxa-3-heptene-1-yne, 2-octene-7-yne, 1,3-butadiyne, 1,3-pentadiyne, 5-fluoro-1,3-pentadiyne, 6-oxa-1,3-heptadiyne, 1,5-hexadiyne, 2,4-hexadiyne, 1,3-hexadiyne, 1,7-octadiyne, phenylacetylene, 1-phenyl-2-propyne, 1-phenyl-1-propyne, 1-phenyl-1-butyne, 4-fluorophenylacetylene, 4-methoxyphenylacetylene, p-diethynylbenzene, m-diethynylbenzene, 2-ethynylphenol, 3-ethynylphenol, 4-ethynylphenol, 2-ethynylnaphthalene, 6-ethynyl-2-naphthol, 5-ethynyl-2-naphthol, 4-ethynyl-4¹-hydroxybiphenyl, 9-ethynylanthracene, 10-ethynyl-9-anthrol, 4-ethynyltoluene, 3-hydroxy-5-ethynyltoluene, 4-fluorophenylacetylene, 3-chloro-5-ethynylphenol, 3-methoxy-5- ethynylphenol, 4-ethynylanisole, (4-ethynylphenyl)(4-hydroxyphenyl) ether, (4-ethynylphenyl)(phenyl) ether, (4-ethynylphenyl)(4-hydroxyphenyl)methane, (4-ethynylphenyl)(phenyl)methane, 4-(3-butenyl-1-ynyl)phenol, 4-(1,3-butadiynyl)phenol and 1,2-bisphenylacetylene.

Next, the process of producing a modified silicone compound represented by the general formula (6) from a silicone polymer containing the Si—H bond and ethynyl-containing compound is described. The reaction system includes a feed supply unit, stirrer in the reactor and temperature controller for the reactor. The reaction may be effected in a solvent, or in the absence of a solvent. The stock compounds of a silicone polymer containing the Si—H group and represented by the general formula (9), ethynyl-containing compound represented by R⁵—C≡C—R⁴, and hydrosilylation catalyst are charged in the reactor, together with a solvent, as required. The hydrosilylation catalyst may be charged in the form of solution or suspension, or directly without being dissolved in a solvent. The starting compounds are reacted with each other for a given time with stirring, while temperature of the reaction solution is controlled at a given level. Then, the solvent is removed by distillation under a vacuum or the polymer is separated out from the effluent, to produce the modified silicone compound.

A transition metal complex catalyst may be used as the hydrosilylation catalyst for the reaction (G). The transition metal complexes useful for the present invention include, but not limited to, complexes of the Group 8 transition metals in Periodic Table, e.g., RhCl(PPh₃)₃, RhBr(PPh₃)₃, RhI(PPh₃)₃, RhCl(PBu₃)₃, Rh₄(CO)₁₂, Rh₆(Co)₁₆, [RhCl(CO)₂]₂, [RhCl(CO)(PPh₃)₂, RhH(CO)(PPh₃)₃, [RhCl(CH₂═CH₂)₂]₂, [RhCl(COD)]₂, [CpRHCl₂]₂, CpRH(CH₂═CH₂)₂, Rh/C, RuCl(PPh₃)₃, RuCl₂(PPh₃)₃, Ru(CO)₅, Ru(CO)₂(PPh₃)₃, Ru(CO)₄PPh₃, RU₃(CO)₁₂, RU₄(CO)₁₂, Ru(PPh₃)₅, [RUCl₂(CO)₃]₂, RuClH(CO)(PPh₃)₃, RuH₂(PPh₃)₄, RuH₄(PPh₃)₃, RuCl₂(PhCN)(PPh₃)₂, [CpRuCl₂]₂, Ru/C, Ru(COD)(COT), Fe(CO)₅, Fe(CO)₃(PPh₃)₂, OS₃(CO)₁₂, OsH₂(CO)(PPh₃)₃, Os/C, Co₂(CO)₈, Co₂(CO)₅(PPh₃)₂, Co₄(CO)₁₂, HCo(CO)₄, CoCl(PPh₃)₃, Ir₄(CO)₁₂, IrCl(CO)(PPh₃)₂, [IrCl(CH₂═CH₂)₂)₂, IrCl(CH₂═CH₂)(PPh₃)₂, [IrCl(COD)]₂, IrCl(PPh₃)₃, IrH₅(PPh₃)₂, Ni(Co)₄, Ni(COD)₂, Ni(CH₂═CH₂)(PPh₃)₂, Ni(PPh₃)₄, NiCl₂(PPh₃)₂, Pd(PMe₃)₂, Pd(PEt₃)₂, Pd(PiPr₃)₂, Pd(PiBu₃)₂, Pd(PBu₃)₂, Pd(P(c—C₆H₁₁)₃)₂, Pd(P(n—C₆H₁₃)₃)₂, Pd(PPh)₃)₂, PdCl₂(PMe)₃)₂, PdCl₂(PEt)₃)₂, PdCl₂(PiPr)₃)₂, PdCl₂(PBu)₃)₂, PdCl₂(P(c—C₆H₁₁)₃)₂, PdCl₂(P(n—C₆H₁₃)₃)₂, PdCl₂(PPh)₃)₂, PdCl₂(RCN)₂, PdCl₂(PPh)₃)₂, PdCl₂(PhNC)₂, PdCl₂(MeNC)₂, Pd(OCOCH₃)₂, Pd(OCOPh)₂, Pd(PPh₃)₄, Pd(CO)(PPh₃)₃, Pd(CH₂═CH₂)(PPh₃)₂, Pd(COD)₂, Pd(dba)₂, PdCl₂(dba)₂, Pd/C, PtCl₂(PhCH═CH₂)₂, PtCl₂(PhCN)₂, PtCl(PPh₃)₂(COD), PtCl₂(PPh₃)₂, PtCl₂(Pet₃)₂, [PtCl₂(CH₂═CH₂)]₂, Pt(COD)₂, PtCl₂(COD)₂, Pt(PPh₃)₄, Pt(PPh₃)₃, Pt(CO)(PPh₃)₃, Pt/CO, PtHCl(PPh₃)₂, H₂PtCl₆, K₂PtCl₆, KPtCl₃(CH₂═CH₂), Na₂PtCl₆, Pt(dba)₂ and Pt(dba)₃, wherein COD is cyclopentadiene, Cp is cyclopentadienyl or pentamethylcyclopentadienyl group, COT is cyclooctatetraene, and dba is benzylidene acetone.

The above catalyst may be incorporated with a ligand, e.g., NEt₃, PiPr₃, P(c—C₆H₁₁)₃ and PPh₃, at 1 to 10 equivalents of the catalyst. The examples of these catalysts include PtCl₂(PPh₃)₂ incorporated with 2 equivalents of NEt₃ and Pd(dba)₂ incorporated with 2 equivalents of PPh₃. These complexes may be used either individually or in combination.

A ratio of the silicone polymer containing the Si—H group and represented by the general formula (9) to the ethynyl-containing compound is not limited. However, the latter compound is preferably used at 1 to 500 mmols per 100 mmols of the Si—H bond in the former, more preferably 10 to 100 mmols. The transition metal complex catalysts and basic catalysts may be used either individually or in combination. The catalyst is dosed at 0.00001 to 200 mmols per 100 mmols of the ethynyl-containing compound, preferably 0.01 to 10 mmols.

The reactor is preferably purged with an inert gas, e.g., high-purity nitrogen or argon gas. The solvents useful for the present invention include aromatic hydrocarbon-based ones, e.g., benzene, toluene, xylene, ethyl benzene and mesitylene; ether-based ones, e.g., diethyl ether, n-butyl ether, anisole, diphenyl ether, tetrahydrofuran, dioxane, bis(2-methoxyethyl) ether and 1,2-bis(2-methoxyethoxy)ethane; halogen-containing ones, e.g., dichloromethane and chloroform; organic polar ones, e.g., N-methyl pyrrolidone, dimethyl formamide and dimethyl acetoamide; and a mixture thereof. Quantity of the solvent is preferably in a range from 0.1 to 40 mL per 1 mmol of the ethynyl-containing compound as the starting compound. The solvent is preferably dehydrated and dried beforehand, because moisture in the solvent may deactivate the catalyst.

Reaction temperature is in a range from −50 to 300° C., preferably 0 to 150° C. Reaction pressure may be normal or elevated pressure. It is however preferably elevated when reaction temperature is above boiling point of the solvent, and in this case a pressure vessel is used for the reactor. Reaction time varies with operating conditions such as temperature,,but is adequate at 0.1 to 200 hours.

Isolation of the modified silicone compound by removing the solvent may be conducted for the as-received reaction effluent solution. However, it is preferable to treat the effluent solution beforehand by dispersion in a saturated aliphatic hydrocarbon, filtration and treatment with an aqueous solution (Japanese Patent Laid-open Publication No. 11-236388) or treatment by a cation-exchanging resin to remove the catalyst.

The saturated aliphatic hydrocarbons useful for removing the catalyst include pentane, hexane, heptane and octane. It is used at 0.01 to 200 mL per 1 g of the silicone polymer containing the SiH bond as the starting compound, preferably 0.1 to 50 mL.

Removal of the catalyst by an adsorbent is effected by treating the reaction effluent solution by the contact filtration or fixed-bed method. More specifically, the reaction effluent is mixed with an adsorbent and stirred for a given time, and the mixture is filtered to remove the resin in the former, whereas the reaction effluent is passed over an adsorbent in a fixed bed, e.g., column or fixed-bed tower, in the latter. The reaction effluent solution is normally treated once, but may be treated 2 to 100 times. Normally, the as-received reaction effluent solution is treated, but it may be diluted 1.1 to 100 times beforehand with a solvent.

The adsorbents useful for the present invention include silica gel, alumina and ion-exchanging resin. The ion-exchanging resins useful for the present invention include a strongly acidic, H type cation-exchanging resin with sulfone group as the exchanging group, weakly acidic H type cation-exchanging resin with carboxyl, phenol or phosphine group as the exchanging group, chelate resin with aminodiacetate or polyamino group, and these resins carried by silica, alumina or the like. These resins may be used either individually or in combination. The adsorbent may be granular or powdery.

Quantity of the adsorbent varies depending on its type and exchanging capacity, catalyst type used, and catalyst quantity in the reaction effluent solution, but is in a range from 0.0001 to 10 g per 1 mL of the solution. Treatment or residence time varies depending on type and quantity of the adsorbent, and catalyst quantity in the reaction effluent solution, but is in a range from 0.001 to 400 hours. Treatment temperature is in a range from −50 to 300° C., preferably 0 to 150° C.

The reaction effluent solution is treated, after the catalyst is removed, by removing the solvent, column separation or precipitation to isolate the modified silicone compound therefrom.

Weight-average molecular weight of the modified silicone compound thus produced is preferably 500 to 1,000,000, more preferably 1,000 to 100,000.

Each of the above-described modified silicone compounds has a Td₅ value (temperature at which it loses weight by 5%), determined by TGA in an inert gas, of at least 300° C., preferably 350° C. or higher.

Process of Setting the Modified Silicone Compound and Cured Product Thereof

The modified silicone compound can be set by the process similar to that used for a common thermosetting resin, e.g., under heating, or by the reaction in the presence of a transition metal, transition metal complex or radical initiator (Japanese Patent Laid-open Publication No. 7-102069). The setting process useful for the present invention is not limited. It can be also formed by various methods, e.g., compression, transfer, laminate and injection molding, and casting. When a thermosetting process is adopted, the atmosphere in which the modified silicone compound is set is not limited, but it is preferably set in an inert gas (e.g., nitrogen, helium or argon) or under a vacuum. Heating temperature is in a range from 50 to 700° C., preferably 50 to below 500° C. Heating time is not limited, but is adequate at 1 minute to 100 hours. Heating temperature and time vary with type and molecular weight of the modified silicone compound, and atmosphere in which it is set. The modified silicone compound set by one of the above processes is useful as the cured product of the present invention.

The cured product has a thermal characteristic of Td₅ value (temperature at which it loses weight by 5%), determined by TGA in an inert gas, of at least 300° C., preferably 350° C. or higher.

The modified silicone compounds and cured products thereof, both of the present invention, can find a variety of applicable areas, as the resins for aerospace devices and circuit substrates, additives for improving resistance of resins to heat, coatings for magnetic cores, and parts for plasma etching devices and plasma displays.

The present invention is described the preferred embodiments by EXAMPLES, which by no means limit the present invention, needless to say.

### EXAMPLE 1-1

2 mmols unit of poly(methylsiloxane) (Azmax's polymethyl-H-siloxane, molecular weight Mw: 1,500 to 1,900) as the H-silicone, 4 mmols of propargyl alcohol, 1 mL of benzene as a solvent and 0.03 mg as atm-Cu of (HCuPPh₃)₆ as a catalyst were stirred at room temperature for 3 hours. Then, 4 mL of hexane was added to the resultant effluent solution, to precipitate the catalyst, and the filtrate was concentrated to produce ([methyl(propargyloxy)siloxane])₂₅ at a yield of 92%.

It was a novel compound, not found in any publication before, having an Mw of 10,200 and Mn of 2,900. The elementary analysis results were C: 40.84% and H: 5.22%. The calculated C and H contents as ([methyl(propargyloxy)siloxane])₂₅ were 42.08 and 5.30%, respectively. ¹HNMR: (C₆D₆) δ 0.1 to 0.5, 0.5 to 2.25 and 4.25 to 4.55 ppm.

It was analyzed for Td₅ value (temperature at which it loses weight by 5%), determined by thermogravimetric analysis (TGA) using an analyzer (Shimadzu's TA-50), where 10 mg of the sample was heated at 10° C./minute in a flow of an inert gas.

It had a Td₅ value of 422° C. by TGA determination in a nitrogen atmosphere, and its residue at 1000° C. was 70%. The DSC analysis showed an exothermic peak at 280° C.

### EXAMPLE 1-2

2 mmols unit of poly(methylsiloxane) as the H-silicone, 2.2 mmols of propargyl alcohol, 1 mL of benzene as a solvent and 0.03 mg as atm-Cu of (HCuPPh₃)₆ as a catalyst were stirred at room temperature for 15 hours. Then, 4 mL of hexane was added to the resultant effluent solution, to precipitate the catalyst, and the filtrate was concentrated to produce poly{[methyl(propargyloxy)siloxane])_{0.97}(methylsiloxane)_{0.03}}₁₂ at a yield of 82%. A ratio of each unit was determined from the integral ratio of the ¹HNMR signals.

It was a novel compound, not found in any publication before, having an Mw of 3,100 and Mn of 1,400. The elementary analysis results were C: 41.39% and H: 5.46%. The calculated C and H contents as {[methyl(propargyloxy)siloxane])_{0.97}(methylsiloxane)_{0.03}}₁₂ were 41.72 and 5.32%, respectively. ²⁹SiNMR: (C₆D₆) δ-56.96 ppm, ¹³CNMR: (C₆D₆) δ 5 to −3.5, 51.00, 73.72 and 81.82 ppm, and ¹HNMR: (C₆D₆) δ 0.1 to 0.6, 2.0 to 2.3 and 4.2 to 4.7 ppm.

It had a Td₅ value of 414° C. by TGA determination in a nitrogen atmosphere, and its residue at 1000° C. was 74%.

### EXAMPLE 1-3

{[Methyl(propargyloxy)siloxane])_{0.89} (methylsiloxane)_{0.11}}₃₀ was produced at a yield of 87% in the same manner as in EXAMPLE 1-1, except that quantity of propagyl alcohol was decreased to 2 mmols.

It was a novel compound, not found in any publication before, having an Mw of 16,200 and Mn of 3,300. The elementary analysis results were C: 39.65% and H: 5.45%. ²⁹SiNMR: (C₆D₆) δ −57.02 ppm, ¹³CNMR: (C₆D₆) δ −3.80, 1.18, 50.94, 73.82 and 81.81 ppm. The calculated C and H contents as {[Methyl(propargyloxy)siloxane])_{0.89}(methylsiloxane)_{0.11}}₃₀ were 40.73 and 5.38%, respectively. ¹HNMR: (C₆D₆) δ 0.5 to 0.55, 2.05 to 2.3, 4.25 to 4.55 and 4.95 to 5.05 ppm, and IR(KBr): 2,167 and 1,080 cm⁻¹.

It had a Td₅ value of 423° C. (at which it lost its weight by 5%) and Td₁₀ value of 471° C. (at which it lost its weight by 10%) by TGA determination in a nitrogen atmosphere, and its residue at 1000° C. was 76%.

### EXAMPLE 1-4

{[Methyl(propargyloxy)siloxane])_{0.47} (methylsiloxane)_{0.53}}₁₀₁ was produced at a yield of 83% in the same manner as in EXAMPLE 1-1, except that quantity of propagyl alcohol was decreased to 1 mmol.

It was a novel compound, not found in any publication before, having an Mw of 29,300 and Mn of 8,600. The elementary analysis results were C: 34.79% and H: 5.88%. ²⁹SiNMR: (C₆D₆) δ −34.43 and −56.42 ppm. ¹³CNMR: (C₆D₆) δ −3.80, 1.10, 50.84, 73.69 and 81.73 ppm. ¹HNMR: (C₆D₆) δ 0.1 to 0.5, 2.05 to 2.2, 4.25 to 4.5 and 4.95 to 5.05 ppm.

It had a Td₅ value of 513° C. and Td₁₀ value of 579° C. by TGA determination in a nitrogen atmosphere, and its residue at 1000° C. was 83%. The DSC analysis showed an exothermic peak at 189° C.

### EXAMPLE 1-5

{[Methyl(propargyloxy)siloxane])_{0.46} (methylsiloxane)_{0.54}}₁₀₈ was produced at a yield of 77% in the same manner as in EXAMPLE 1-1, except that quantity of propagyl alcohol was decreased to 1 mmol.

It was a novel compound, not found in any publication before, having an Mw of 23,100 and Mn of 9,200. The elementary analysis results were C: 33.63% and H: 5.83%. The calculated C and H contents as {[Methyl(propargyloxy)siloxane])_{0.46}(methylsiloxane)_{0.54}}₁₀₈ were 33.63 and 5.84%, respectively. ²⁹SiNMR: (C6D₆) δ −34.47 and −56.45 ppm. ¹³CNMR: (C₆D₆) δ −3.81, 1.36, 50.80, 73.71 and 81.67 ppm. ¹HNMR: (C₆D₆) δ 0.1 to 0.5, 2.05 to 2.2, 4.3 to 4.5 and 5.04 ppm.

It had a Td₅ value of 507° C. and Td₁₀ value of 595° C. by TGA determination in a nitrogen atmosphere, and its residue at 1000° C. was 83%.

### EXAMPLE 1-6

{[Methyl(propargyloxy)siloxane])_{0.38} (methylsiloxane)_{0.62}}₁₇₆ was produced at a yield of 85% in the same manner as in EXAMPLE 1-1, except that quantity of propagyl alcohol was decreased to 0.5 mmols.

It was a novel compound, not found in any publication before, having an Mw of 31,600 and Mn of 14,300. The elementary analysis results were C: 28.82% and H: 6.25%. ²⁹SiNMR: (C₆D₆) δ −34.5 and −55.80 ppm. ¹³CNMR: (C₆D₆) δ −382, 1.07, 50.77, 73.60 and 81.8 ppm. ¹HNMR: (C₆D₆) δ 0.05 to 0.5, 2.05 to 2.15, 4.2 to 4.4 and 4.9 to 5.1 ppm.

It had a Td₅ value of 537° C. and Td₁₀ value of 667° C. by TGA determination in a nitrogen atmosphere, and its residue at 1000° C. was 84%.

### EXAMPLE 1-7

[Methyl(3-phenylpropargyloxy)siloxane])₅₀ was produced at a yield of 76% in the same manner as in EXAMPLE 1-1 except that propagyl alcohol was replaced by 2.4 mmols of 3-phenylpropargyl alcohol.

It was a novel compound, not found in any publication before, having an Mw of 28,700 and Mn of 9,500. The elementary analysis results were C: 55.76% and H: 5.20%. ²⁹SiNMR: (C₆D₆) δ −56.5 ppm. ¹³CNMR: (C₆D₆) δ −3.58, 51.80, 85.53, 87.84, 123.41, 128.52 and 132.01 ppm. ¹HNMR: (C₆D₆) δ 0.1 to 0.6, 4.5 to 5.0, 6.85 to 7.1 and 7.35 to 7.5 ppm.

It had a Td₅ value of 403° C. by TGA determination in a nitrogen atmosphere, and its residue at 1000° C. was 51%. The DTA analysis showed an exothermic peak at 280° C.

### EXAMPLE 1-8

[Methyl(3-phenylpropargyloxy)siloxane])_{0.49} (methylsiloxane)_{0.51}]₁₁₇ was produced at a yield of 73% in the same manner as in EXAMPLE 1-7, except that quantity of 3-phenylpropargy alcohol was decreased to 0.95 mmols.

It was a novel compound, not found in any publication before, having an Mw of 28,800 and Mn of 14,600. The elementary analysis results were C: 48.30% and H: 6.05%. ²⁹SiNMR: (C6D₆) δ −34.76 and −55.77 ppm. ¹³CNMR: (C₆D₆) δ −3.59, 1.15, 51.58, 85.52, 87.62, 123.37, 128.51, 129.11 and 131.96 ppm. ¹HNMR: (C₆D₆) δ 0.1 to 0.5, 4.6 to 4.8, 4.95 to 5.15, 6.92 to 7.07 and 7.37 to 7.48 ppm.

It had a Td₅ value of 427° C. by TGA determination in a nitrogen atmosphere, and its residue at 1000° C. was 73%.

### EXAMPLE 1-9

{(Methylsiloxane)_{0.19}[methyl(propargyloxy)siloxane]}_{0.29} (phenylmethylsiloxane)_{0.52}}₉₈ was produced at a yield of 59% in the same manner as in EXAMPLE 1-2, except that poly[(methylsiloxane)_{0.48}[phenylmethylsiloxane])0.52]₄₁ was used as the H-silicone, quantity of propargy alcohol was increased to 3 mmols and stirring time was decreased to 4.5 hours.

It was a novel compound, not found in any publication before, having an Mw of 43,200 and Mn of 11,300. The elementary analysis results were C: 49.30% and H: 5.82%. ²⁹SiNMR: (C₆D₆) δ −32.0, −35.1 and −56.9 ppm. ¹³CNMR: (C₆D₆) δ −3.55, −0.16, 1.43, 50.85, 73.59, 81.85, 128.13, 130.21, 133.72 and 137.12 ppm. ¹HNMR: (C₆D₆) δ 0.1 to 0.3 to 0.8, 1.9 to 2.15, 4.1 to 4.6, 4.9 to 5.2, 7 to 7.4 and 7.5 to 7.9 ppm.

It had a Td₅ value of 493° C. by TGA determination in a nitrogen atmosphere, and its residue at 1000° C. was 73%. The DTA analysis showed an exothermic peak at 215° C.

### EXAMPLE 1-10

{(Methylsiloxane)_{0.39}[methyl(propargyloxy)siloxane]}_{0.09} (phenylmethylsiloxane)_{0.52}}₆₇ was produced at a yield of 71% in the same manner as in EXAMPLE 1-9, except that quantity of propargy alcohol was decreased to 0.8 mmols.

It was a novel compound, not found in any publication before, having an Mw of 36,500 and Mn of 7,000. The elementary analysis results were C: 45.66% and H: 6.01%. 29SiNMR: (C₆D₆) δ −31.95, −35.20 and −56.21 ppm. ¹³CNMR: (C₆D₆) δ 0.58, 1.33, 50.78, 73.52, 128.13, 130.19, 133.69 and 137.14 ppm. ¹HNMR: (C₆D₆) δ 0.05 to 0.3, 0.3 to 0.65, 1.95 to 2.1, 4.15 to 4.45, 4.95 to 5.25, 7.1 to 7.4 and 7.6 to 7.9 ppm.

It had a Td₅ value of 419° C. and Td₁₀ value of 516° C. by TGA determination in a nitrogen atmosphere, and its residue at 1000° C. was 50%.

### EXAMPLE 1-11

[(Methylsiloxane)]_{0.42}[methyl(4-hydroxy-3-butynyloxysiloxane)]_{0.02}(phenylmethylsiloxane)_{0.56}}₈₄ was produced at a yield of 72% in the same manner as in EXAMPLE 1-9 except that propagyl alcohol was replaced by 0.04 mmols of 1,4-butynylenediol and used 0.005mgat-cu of (HcuPPh₃)₆ as a catalyst.

It was a novel compound, not found in any publication before, having an Mw of 16,400 and Mn of 8,800: ¹HNMR: (C₆D₆) δ0.05 to 0.6, 4.2 to 4.6, 4.9 to5.3, 7.1 to 7.3 and 7.55 to 7.95 ppm.

It had a Td₅ value of 356° C. and Td₁₀ 387° C. by TGA determination in a nitrogen atmosphere, and its residue at 1000° C. was 50%.

### EXAMPLE 1-12

A 100 mL glass container equipped with a magnetic stirrer therein was purged with a high-purity nitrogen gas, and charged with 76.16 g of poly(methyl hydrogen siloxane) and 34.73 g of propargyl alcohol as the starting compounds and 347 g of toluene as a solvent. A solution of 5.136 g of (HCuPPh₃)6 dissolved in 90 g of toluene was added dropwise to the reaction solution prepared above, and the mixture was stirred at 25° C. for 4 hours. The resultant reaction solution was transferred to a 3,000 mL container holding 1301 g of hexane, and the mixture was left over a night to precipitate the catalyst, which was removed by filtration with a polyflon filter. The filtrate was concentrated at 35° C. by an evaporator, and then dried at 40° C. under a vacuum (3 mmHg) for 12 hours. This resulted in production of 112.33 g of the modified silicone compound as the target product, which was a transparent liquid tinged with yellow, at a yield of 98%. It had a weight-average molecular weight of 11,000 as polystyrene, determined by gel permeation chromatography (GPC). The Si—H/Si—OCH₂C≡CH ratio, determined by H-NMR was 49/51.

### EXAMPLE 1-13

2.1 g of the modified silicone compound prepared in EXAMPLE 1-12, put in a Teflon mold, was set under heating at 240° C. for 2 hours in a nitrogen atmosphere. The cured product was crushed in a mortar, and analyzed for its thermal properties by TGA in accordance with JIS K-1120. It had a Td₅ value (temperature at which it loses weight by 5%) of 500° C. in an argon atmosphere. In addition, its 5 weight residue at 1000° C. was 81%.

### EXAMPLE 1-14

4.8 g of the modified silicone compound prepared in EXAMPLE 1-12, put in a Teflon mold, was set under heating at 220° C. for 4 hours in a nitrogen atmosphere, and further treated at 400° C. for 2 hours in an argon atmosphere, to prepare the cured product of the modified silicone compound, black in color.

It was ground to a thickness of about 1.5 mm and cut into a 2 mm wide test piece for 3-point bending test by is an analyzer (Perkin Elmer's DMA7) under the conditions of fulcrum-fulcrum distance of 1.5 mm and loading rate of 500 mN/minute. The analysis results are given in Table 1.

TABLE 1
Analysis results of the cured product properties

| | Sample size | | Analysis results | |
|---|---|---|---|---|
| | | Thickness | Strength | Modulus of elasticity |
| No. | Width (nm) | (mm) | (MPa) | (GPa) |
| 1 | 2.34 | 1.66 | 17.0 | 0.77 |
| 2 | 2.05 | 1.48 | 14.1 | 1.07 |
| 3 | 2.00 | 1.22 | 13.0 | 0.86 |

### EXAMPLE 2-1

A 100 mL glass container equipped with a magnetic stirrer therein was purged with a high-purity nitrogen gas, and charged with 2.41 g of poly(methyl hydrogen siloxane) and 2.35 g (19.9 mmols) of 3-ethynyl phenol as the starting compounds, and 0.196 g of triphenylphosphine copper halide complex hexamer as the catalyst and 20 mL of toluene as a solvent. The mixture was stirred at 30° C. for 4 hours. The resultant reaction solution was dispersed in 80 mL of hexane to precipitate the catalyst, and filtered by a glass filter. The filtrate was concentrated at 60° C. for 12 hours under a vacuum. This resulted in production of 3.87 g of the modified silicone compound as the target product at a yield of 82%. It had a weight-average molecular weight of 25,400 as polystyrene standard, determined by gel permeation chromatography (GPC).

The elementary analysis results were C: 38.2% and H: 4.1%.

¹H-NMR analysis results (ppm, CDCl₃): 0.1 to 0.4 (Si—C—H), 3.0 (C≡C—H), 4.7(SiH), and 6.9 to 8.1 (Ph-H)

IR analysis results (cm⁻¹) were 841, 1107, 1264, 2185 and 2961.

Next, the novel modified silicone compound was analyzed for its thermal properties by TGA. It had a Td₅ value (temperature at which it loses weight by 5%) of 521° C. in an argon atmosphere. Its weight residue at 1000° C. was 83%.

### EXAMPLE 2-2

2.4 g of the modified silicone compound prepared in EXAMPLE 2-1, put in a Teflon mold, was set under heating at 150° C. for 5 hours in a nitrogen atmosphere, to prepare the cured product of the modified silicone compound. It was analyzed for its thermal properties by TGA. It had a Td₅ value (temperature at which it loses weight by 5%) of 530° C. in an argon atmosphere. Furthermore, its weight residue at 1000° C. was 83%.

### COMPARATIVE EXAMPLE 2-1

The poly(dihydrogen siloxane) was analyzed for its thermal properties by TGA. It had a Td₅ value (temperature at which it loses weight by 5%) of 228° C. in an argon atmosphere. Furthermore, its weight residue at 1000° C. was 4%.

These results clearly indicate difference between poly(dihydrogen siloxone) and the modified silicone compound is produced by the reaction between the silicone polymer containing the Si—H bond and ethynyl-containing alcohol compound in the presence of the dehydrocoupling catalyst.

### EXAMPLE 3-1

A 300 mL glass container was charged with 80 mL of 15% hydrochloric acid, to which 120 mL of an ether solution dissolving 12.76 g of dichlorosilane and 16.14 g of dimethyldichlorosilane was added dropwise with stirring and cooling to control the reaction temperature at 10° C. or lower, for the hydrolysis reaction. On completion of the reaction, the upper layer (ether layer) was withdrawn and washed twice each with 50 mL of water. It was dried with 20 g of calcium sulfate, and treated in an evaporator to remove the ether. This resulted in production of 11.98 g of an H type silicone oligomer at a yield of 79%.

Next, 10.21 g of the H type silicone oligomer, 0.05 g of hexamethyldisiloxane and 5.05 g of concentrated sulfuric acid, put in a 100 mL glass container, were stirred at room temperature for 6 hours, to which 5 mL of water was added. The mixture was stirred for 0.5 hours, and the H type silicone forming the upper layer was withdrawn. It was incorporated with 1.01 g of sodium sulfate and 1.04 g of sodium carbonate, and the mixture was left to stand for 24 hours. This resulted in production of 7.48 g of a poly[(dihydrogen siloxane)(dimethylsiloxane)] copolymer as an oily silicone polymer containing the Si—H bond, at a yield of 73%. It had a weight-average molecular weight of 16,700 as polystyrene standard, determined by gel permeation chromatography (GPC). The elementary analysis results were C: 9.7% and H: 4.9%.

### EXAMPLE 3-2

A 100 mL glass container equipped with a magnetic stirrer therein was purged with a high-purity nitrogen gas, and charged with 2.44 g of the poly[(dihydrogen siloxane)(dimethylsiloxane)] copolymer prepared in EXAMPLE 3-1 and 2.39 g (20.3 mmols) of 3-ethynyl phenol as the starting compounds, and 201 mg of triphenylphosphine copper halide complex hexamer as the catalyst and 20 mL of toluene as a solvent. The mixture was stirred at 30° C. for 4 hours. The resultant reaction solution was dispersed in 80 mL of hexane to precipitate the catalyst, and filtered by a glass filter. The filtrate was concentrated at 60° C. for 12 hours under a vacuum. This resulted in production of 3.39 g of the modified silicone compound as the target product at a yield of 70%. It had a weight-average molecular weight of 18,700 as polystyrene standard, determined by gel permeation chromatography (GPC). The elementary analysis results were C: 38.3% and H: 4.2%.

¹H-NMR analysis results (ppm, CDCl₃); 0.1 to 0.5 (Si—C—H), 3.0 (C≡C—H), 4.6 (SiH), and 6.9 to 8.1 (Ph-H)

IR analysis results (cm⁻¹) were 844, 1105, 1260, 2179, 2949 and 3280.

Next, the novel modified silicone compound was analyzed for its thermal properties by TGA. It had a Td₅ value (temperature at which it loses weight by 5%) of 514° C. in an argon atmosphere. Its weight residue at 1000° C. was 79%.

### EXAMPLE 3-3

2.1 g of the modified silicone compound prepared in EXAMPLE 3-2, put in a Teflon mold, was set under heating at 150° C. for 5 hours in a nitrogen atmosphere, to prepare the cured product of the modified silicone compound. It was analyzed for its thermal properties by TGA. It had a Td₅ value (temperature at which it loses weight by 5%) of 517° C. in an argon atmosphere. Furthermore, its weight residue at 1000° C. was 81%.

### EXAMPLE 4-1

A 100 mL glass container equipped with a magnetic stirrer therein was purged with a high-purity nitrogen gas, and charged with 2.41 g of a poly(methyl hydrogen siloxane) and 2.67 g (19.9 mmols) of cinnamic alcohol as the starting compounds, and 0.196 g of triphenylphosphine copper halide complex hexamer as the catalyst and 20 mL of toluene as a solvent. The mixture was stirred at 30° C. for 4 hours. The resultant reaction solution was dispersed in 80 mL of hexane to precipitate the catalyst, and filtered by a glass filter. The filtrate was concentrated at 60° C. for 12 hours under a vacuum. This resulted in production of 4.27 g of the modified silicone compound as the target product at a yield of 84%. It had a weight-average molecular weight of 8,950 as polystyrene, determined by gel permeation chromatography (GPC).

The elementary analysis results were C: 52.2% and H: 7.1%.

¹H-NMR analysis results (ppm, CDCl₃): 0.1 to 0.4 (Si—C—H), 4.3 (C—H₂), 4.7 (SiH), 6.3 to 6.6 (CH═CH) and 6.9 to 8.1 (Ph-H)

IR analysis results (cm⁻¹) were 745, 1098, 1494, 2187 and 3024

Next, the novel modified silicone compound was analyzed for its thermal properties by TGA. It had a Td₅ value (temperature at which it loses weight by 5%) of 545° C. in an argon atmosphere. Its weight residue at 1000° C. was 74%.

### EXAMPLE 4-2

2.5 g of the modified silicone compound prepared in EXAMPLE 4-1, put in a Teflon mold, was set under heating at 150° C. for 5 hours in a nitrogen atmosphere, to prepare the cured product of the modified silicone compound. It was analyzed for its thermal properties by TGA. It had a Td₅ value (temperature at which it loses weight by 5%) of 545° C. in an argon atmosphere. Its weight residue at 1000° C. was 85%.

### EXAMPLE 4-3

A 100 mL glass container equipped with a magnetic stirrer therein was purged with a high-purity nitrogen gas, and charged with 2.41 g of a poly(methyl hydrogen siloxane) and 0.197 g (17.6 mmols) of butenediol as the starting compounds, and 0.197 g of triphenylphosphine copper halide complex hexamer as the catalyst and 20 mL of toluene as a solvent. The mixture was stirred at 30° C. for 4 hours. The resultant reaction solution was dispersed in 80 mL of hexane to precipitate the catalyst, and filtered by a glass filter. The filtrate was concentrated at 60° C. for 12 hours under a vacuum. This resulted in production of 2.78 g of the modified silicone compound as the target product at a yield of 76%. It had a weight-average molecular weight of 24,910 as polystyrene standard, determined by gel permeation chromatography (GPC). The elementary analysis results were C: 33.4% and H: 6.9%.

¹H-NMR analysis results (ppm, CDCl₃): 0.1 to 0.5 (Si—C—H), 4.2 (C—H₂), 4.7 (SiH), and 5.7 to 5.9 (CH₂═CH₂)

IR analysis results (cm⁻¹) were 1018, 1422, 2175, 2914 and 3320.

Next, the novel modified silicone compound was analyzed for its thermal properties by TGA. It had a Td₅ value (temperature at which it loses weight by 5%) of 476° C. in an argon atmosphere. Its weight residue at 1000° C. was 64%.

### EXAMPLE 4-4

2.2 g of the modified silicone compound prepared in EXAMPLE 4-1, put in a Teflon mold, was set under heating at 150° C. for 5 hours in a nitrogen atmosphere, to prepare the cured product of the modified silicone compound. It was analyzed for its thermal properties by TGA. It had a Td₅ value (temperature at which it loses weight by 5%) of 496° C. in an argon atmosphere. Its weight residue at 1000° C. was 78%.

### EXAMPLE 5-1

7.4 g of magnesium hydroxide having a particle size of 30 to 60 meshes, charged in a quartz sintering tube, was thermally decomposed at 350° C. for 3 hours under a vacuum (0.4 kPa) to prepare 5.1 g of magnesium oxide, which was used as a basic catalyst for the following reaction.

A 100 mL glass container equipped with a magnetic stirrer therein was purged with a high-purity nitrogen gas, and charged with 2.421 g of a poly(methyl hydrogen siloxane) and 2.03 g (20 mmols) of phenylacetylene as the starting compounds, and 20 mL of toluene as a solvent, to which 5.1 g of the magnesium oxide prepared above was added while the system was sealed with nitrogen. The mixture was stirred at 30° C. for 1 hour, 40° C. for 1 hour, 50° C. for 1 hour, 60° C. for 1 hour, and 80° C. for 2 hours. The resultant reaction solution was filtered by a polyflon filter to remove the catalyst. The filtrate was concentrated at 60° C. for 12 hours under a vacuum. This resulted in production of 3.06 g of the modified silicone compound as the target product at a yield of 69%. It had a weight-average molecular weight of 26,200 as polystyrene standard, determined by gel permeation chromatography (GPC). The elementary analysis results were C: 51.2% and H: 5.1%.

¹H-NMR analysis results (ppm, CDCl₃): 0.1 to 0.4 (Si—C—H), 4.8 (SiH), and 6.9 to 8.2 (Ph-H)

IR analysis results (cm^{31 1}) were 837, 1116, 1241, 2162 and 2941.

Next, the novel modified silicone compound was analyzed for its thermal properties by TGA. It had a Td₅ value (temperature at which it loses weight by 5%) of 544° C. in an argon atmosphere. Its weight residue at 1000° C. was 85%.

### EXAMPLE 5-2

1.9 g of the modified silicone compound prepared in EXAMPLE 5-1, put in a Teflon mold, was set under heating at 150° C. for 5 hours in a nitrogen atmosphere, to prepare the cured product of the modified silicone compound. It was analyzed for its thermal properties by TGA. It had a Td₅ value (temperature at which it loses weight by 5%) of 548° C. in an argon atmosphere. Its weight residue at 1000° C. was 86%.

### EXAMPLE 6-1

A 100 mL glass container equipped with a magnetic stirrer therein was purged with a high-purity nitrogen gas, and charged with 2.41 g of a poly(methyl hydrogen siloxane) and 2.05 g (20 mmols) of phenylacetylene as the starting compounds, and 0.334 g (0.04 mmols) of bis(tricyclohexylphosphine)palladium triphenylphosphine copper halide complex hexamer as the catalyst and 20 mL of toluene as a solvent. The mixture was stirred at 40° C. for 6 hours. The resultant reaction solution was dispersed in 80 mL of hexane to precipitate the catalyst, and filtered by a glass filter. The filtrate was concentrated at 60° C. for 12 hours under a vacuum. This resulted in production of 3.37 g of the modified silicone compound as the target product at a yield of 76%. It had a weight-average molecular weight of 21,400 as polystyrene standard, determined by gel permeation chromatography (GPC). The elementary analysis results were C: 49.7% and H: 6.4%.

¹H-NMR analysis results (ppm, CDCl₃): 0.1 to 0.4 (Si—C—H), 4.7 (SiH), 5.9 to 6.3 (C≡C—H) and 6.9 to 8.1 (Ph-H)

IR analysis results (cm^{31 1}) were 841, 962, 1107, 1264, 1670, 2115 and 2961

Next, the novel modified silicone compound was analyzed for its thermal properties by TGA. It had a Td₅ value (temperature at which it loses weight by 5%) of 511° C. in an argon atmosphere. Its weight residue at 1000° C. was 74%.

### EXAMPLE 6-2

2.2 g of the modified silicone compound prepared in EXAMPLE 6-1, put in a Teflon mold, was set under heating at 150° C. for 5 hours in a nitrogen atmosphere, to prepare the cured product of the modified silicone compound. It was analyzed for its thermal properties by TGA. It had a Td₅ value (temperature at which it loses weight by 5%) of 518° C. in an argon atmosphere. In addition, its weight residue at 1000° C. was 78%.

1. A modified silicone compound having an Si—H bond and an unsaturated carbon-carbon bond, represented by the general formula (1): 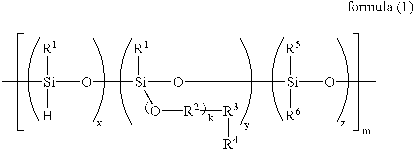
(wherein R¹ and R⁴ are each hydrogen or a monovalent organic group; R² is a divalent organic group; R₅ and R⁶ are each a monovalent organic group and may be the same or different; R³ is a divalent group having an unsaturated carbon-carbon bond, represented by —C≡C— or —C(R⁷)═C(R⁸)—; R⁷ and R⁸ are each hydrogen or a monovalent organic group and may be the same or different; k is 0 or 1; y is more than 0 but less than 1; x and z are each 0 or more but less than 1, satisfying the relationship x+y+z=1; x is not 0 when R¹ is not hydrogen; m is an integer of 3 or more; but constituent elements may be optionally arranged; each of the structures ( )ₓ, ( )_{y} and ( )_{z} may contain 2 or more different structures so long as they are defined; and R¹ may be a monovalent organic group represented by (O—R²)ₖ—R³—R⁴).

2. A cured product obtained by setting the modified silicone compound according to claim 1 thermally and/or in the presence of a catalyst.

3. The modified silicone compound having the Si—H and the carbon-carbon triple bond according to claim 1, wherein R¹, R³ and k in the general formula (1) are a monovalent organic group, —C≡C— and 1, respectively.

4. A cured product obtained by setting the modified silicone compound according to claim 3 thermally and/or in the presence of a catalyst.

5. The modified silicone compound having the Si—H bond and the carbon-carbon triple bond according to claim 1, which is represented by the general formula (2): 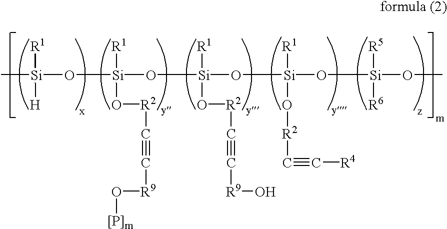
(wherein R¹ is a monovalent organic group; R², R⁴, R⁵ and R⁶ are the same as R₂, R⁴, R⁵ and R⁶ defined in (claim 1); R⁹ is a divalent organic bond; x is more than 0 but less than 1; y″, y″′, y″″ and z are each 0 or more but less than 1, satisfying the relationship x+y″+y″′+y″″+z=1; y″ and y″′ are not 0 simultaneously; m is an integer of 3 or more; P is a composition of the polymer in the []ₘ; but constituent elements may be optionally arranged).

6. A cured product obtained by setting the modified silicone compound according to claim 5 thermally and/or in the presence of a catalyst.

7. The modified silicone compound having the Si—H bond and the carbon-carbon triple bond according to claim 1, which is represented by the general formula (3): 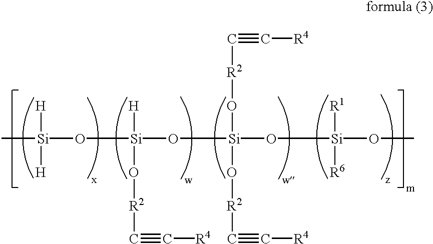
(wherein R′, R₂, R₄ and R⁶ are the same as R′, R², R⁴ and R⁶ defined in (claim 1); x and w″ are each 0 or more but less than 1, z is 0 or more but less than 1; w is 0 or more but 1 or less, satisfying the relationship x+w+w″+z=1; w and w″ are not 0 simultaneously; x and w may be 0 simultaneously when R¹ is hydrogen; x and w are not 0 simultaneously when R¹ is not hydrogen; m is an integer of 3 or more; but constituent elements may be optionally arranged).

8. A cured product obtained by setting the modified silicone compound according to claim 7 thermally and/or in the presence of a catalyst.

9. The modified silicone compound having the Si—H bond and the carbon-carbon double bond according to claim 1, wherein —R³ and k in the general formula (1) are —C(R⁷)═C(R⁸)— and 1, respectively.

10. A cured product obtained by setting the modified silicone compound according to claim 9 thermally and/or in the presence of a catalyst.

11. The modified silicone compound having the Si—H bond and the carbon-carbon double bond according to claim 1, which is represented by the general formula (4): 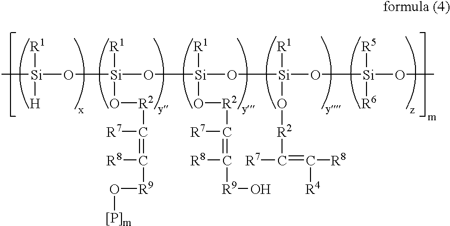
(wherein R¹ is a monovalent organic group; R², R⁴, R₅, R_{6,} R₇ and R⁸ are the same as R², R⁴, R⁵, R⁶, R⁷ and R⁸ defined in (claim 1); R⁹ is the same as R⁹ defined in (claim 5); x and y″″ are each more than 0 but less than 1; y″, y″′ and z are each 0 or more but less than 1; satisfying the relationship x+y″+y″′+z=1; y″ and y″′ are not 0 simultaneously; m is an integer of 3 or more; P is a composition of the polymer in the []ₘ; but constituent elements may be optionally arranged).

12. A cured product obtained by setting the modified silicone compound according to claim 11 thermally and/or in the presence of a catalyst.

13. The modified silicone compound having the Si—H bond and the carbon-carbon triple bond according to claim 1, which is represented by the general formula (5): 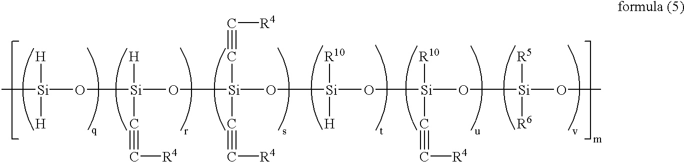
(wherein R⁴, R¹ and R⁶ are the same as R⁴, R¹ and R⁶ defined in (claim 1); R¹⁰ is a monovalent organic group; q, r, s, t, u and v are each 0 or more but less than 1, satisfying the relationship q+r+s+t+u+v=1; r, s and u are not 0 simultaneously; q, r and t are not 0 simultaneously; m is an integer of 3 or more; but constituent elements may be optionally arranged).

14. A cured product obtained by setting the modified silicone compound according to claim 13 thermally and/or in the presence of a catalyst.

15. The modified silicone compound having the Si—H bond and the carbon-carbon double bond according to claim 1, which is represented by the general formula (6): 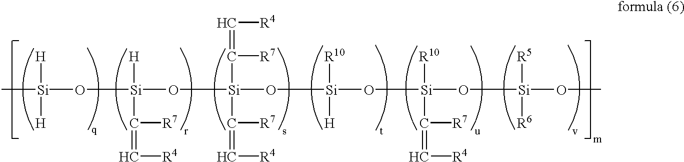
(wherein R⁴ is a monovalent organic group; R⁵, R⁷ and R⁷ are the same as R⁵, R⁷ and R⁷ defined in (claim 1); R¹⁰ is the same as R¹⁰ defined in (claim 13); q, r, s, t, u and v are the same as q, r, s, t, u and v defined in (claim 13); m is an integer of 3 or more; but constituent elements may be optionally arranged).

16. A cured product obtained by setting the modified silicone compound according to claim 15 thermally and/or in the presence of a catalyst.

17. The process of producing the modified silicone compound according to claim 3 or 5, comprising a step of reacting an H-silicone represented by the general formula (7): 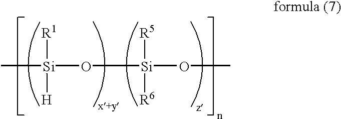
(wherein R¹, R¹ and R⁶ are the same as R¹, R¹ and R⁶ defined in (claim 1); x′+y′ is more than 0 but 1 or less, and z′ is 0 or more but less than 1, satisfying the relationship x′+y′+z′=1, and n is an integer of 3 or more), in a dehydrogenation manner, with an alkynyl alcohol represented by HO—R²—C≡C—R⁴ (wherein R² and R⁴ are the same as R² and R⁴ defined in (claim 1)) and/or an alkynylenediol represented by HO—R —C≡C—R₉—OH (wherein R is the same as R² defined in (claim 1) and R⁹ is the same as R⁹ defined in (claim 5)).

18. The process of producing the modified silicone compound according to claim 7, comprising a step of reacting an H-silicone represented by the general formula (8): 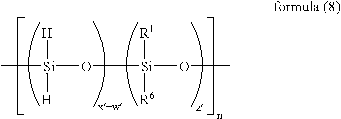
(wherein R¹ and R⁵ are the same as R¹ and R⁵ defined in (claim 1); x′, w′, and z′ are each 0 or more but less than 1, satisfying the relationship x′+w′+z′=1; x′ and w, are not 0 simultaneously; n is an integer of 3 or more; but constituent elements may be optionally arranged) with an alkynyl alcohol represented by HO—R²—C≡C—R⁴ (wherein R² and R⁴ are the same as R² and R⁴ defined in (claim 1)) in the presence of a dehydrocoupling catalyst.

19. The process of producing the modified silicone compound according to claim 9 or 10, wherein an H-silicone represented by the general formula (7) is reacted in a dehydrogenation manner with an alkenyl alcohol represented by HO—R²—C(R⁷)═C(R⁸)—R⁴ (wherein R², R⁴, R⁷ and R¹ are the same as R², R⁴, R⁷ and R⁸ defined in (claim 1)) and/or an alkenylenediol represented by HO—R²—C(R⁷)═C(R⁸)—R⁹—OH (wherein R², R⁷ and R⁸ are the same as R², R⁷ and R⁸ defined in (claim 1) and R⁹ is the same as R⁹ defined in (claim 5)).

20. The process of producing the modified silicone-compound according to claim 18, wherein an H-silicone represented by the general formula (9): 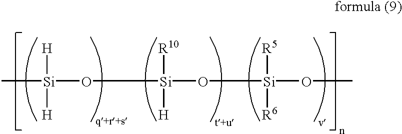
(wherein R⁵ and R⁶ are the same as R⁵ and R⁶ defined in (claim 1); R¹⁰ is the same as R¹⁰ defined in (claim 13); q′, r′, s′, t′, u′ and v′ are each 0 or more but less than 1, satisfying the relationship q+r′+s′+t′+u′+v′=1; n is an integer of 3 or more; but constituent elements may be optionally arranged) is reacted with a compound having an ethynyl group represented by H—C≡C—R⁴ (wherein R⁴ is the same as R⁴ defined in (claim 1)) in the presence of a dehydrocoupling catalyst.

21. The process of producing the modified silicone compound according to claim 15, wherein a silicone polymer containing the Si—H bond and represented by the general formula (9) is reacted with a compound having an ethynyl group and represented by R⁴—C≡C—R⁷ (wherein R⁴ and R⁷ are the same as R⁴ and R⁷ defined in (claim 1)) in the presence of a hydrosilylation catalyst.
